(19) United States
(12) Patent Application Publication
(10) Pub. No.: US 2023/0257610 A1
(43) Pub. Date: Aug. 17, 2023

(54) ENERGY CURABLE INKJET INKS FOR CONTAINER DECORATION

(71) Applicant: INX International Ink Co., Schaumburg, IL (US)

(72) Inventors: Xiang Jun Liu, Schaumburg, IL (US); Jonathan B. Graunke, South Elgin, IL (US); Borpit Intawiwat, Schaumburg, IL (US); Jamie Bennett, Schaumburg, IL (US)

(21) Appl. No.: 18/169,036

(22) Filed: Feb. 14, 2023

Related U.S. Application Data
(60) Provisional application No. 63/309,931, filed on Feb. 14, 2022.

(51) Int. Cl. C09D 11/38; C09D 11/322; B41M 5/00

(52) U.S. Cl. CPC C09D 11/38; C09D 11/322; B41M 5/0047; B41M 5/0058; B41M 5/0017

(57) ABSTRACT

Disclosed herein are ink compositions that can be ink jetted onto a substrate with improved performance, low odor, and low migration properties. An example ink composition includes a mono-functional monomer, the mono-functional monomer including a hydrophilic mono-functional monomer; a di-functional monomer; an optional colorant; and an optional photoinitiator. Also disclosed are substrates decorated with a cured ink composition and methods of decorating a substrate with the ink compositions.

### CROSS-REFERENCE TO RELATED APPLICATIONS

This application claims priority to U.S. Provisional Patent Application No. 63/309,931 filed on Feb. 14, 2022, which is incorporated by reference herein in its entirety.

### FIELD OF INVENTION

The present disclosure relates to an energy curable inkjet ink composition and its application in container decoration. Inkjet compositions having useful adhesion properties and low odor can be beneficial in the decoration of beverage containers.

### BACKGROUND OF INVENTION

Beverages such as beer and soft drinks are mainly packed and sold in aluminum cans, glass bottles, and plastic bottles. In the beverage industry, a great number of aluminum cans are used, often called a two-piece can. The two-piece can itself is a packaging container with a bottom end and body shaped from one sheet of metal by deep drawing, and a second end seamed to the can to close it and form a complete package for sale. As the whole can is composed of two pieces.

The can body of the two-piece can may be partially or fully decorated (printed) through some traditional printing routes (such as dry offset), which imparts vital imaging information onto the can surface and thus makes the aluminum cans more appealing to consumers. The traditional printing routes, however, require image carriers (such as printing plates/blankets) that must be prepared in advance for each of the colors and for each of the jobs. This is undesirable for the beverage can manufacturers as the plate-related cost can only be recouped by implementing a so-called “long run printing” that requires hundreds or thousands of the cans to be printed for each run and for each job. Similar issues can arise in printing on paper-based cartons, plastic bottles and labels, and the like.

Short run printing, however, is becoming more popular in the packaging industry as it provides manufacturers and consumers more freedom and flexibility in imaging design and in brand Logo upgrades. Inkjet printing, particularly, the energy curable inkjet printing is considered more suitable for short run printing. Firstly, this printing approach does not need imaging carriers for the jobs to be printed. It reduces the cost due to the consumption of plate, plate making material, and plate making time. Secondly, short run printing cuts down the time it takes to apply a new design to a substrate. It can vary the color (imaging information) on-demand and the jobs can be done on a computer-to-print basis. This makes it feasible to print single-piece jobs or to print short-run jobs for various brands and consumers. Thirdly, the inkjet printing approach may apply inks wet-on-dry, or wet-on-wet, one on top of the other, to match every possible shade and hue. This results in a much sharper image and makes it possible to print photorealistic designs. When the energy curable inkjet printing is engaged to a container, it may provide additional benefits which include fast cure, high gloss, low VOCs, better water resistance, better solvent resistance, and better chemical resistance.

Several challenges, however, exist when an energy curable inkjet ink (e.g., a UV curable ink or a LED curable ink) is applied to a beverage container, such as a two-piece aluminum beverage can. This is because, according to the general practice in the beverage can industry, the two-piece can decoration usually includes three steps:
print the inks onto the outside surface of the can body and have the inks cured;
immediately apply a layer of water-based overprint varnish, for protection purpose, on the surface of the cured ink and have the can baked at a relatively high temperature (e.g., 350° F. to 400° F. for a few minutes). This ensures both the overprint varnish and the barrier coat (e.g., epoxy coat) inside the can are fully thermally cured; and
pasteurize the can following the beverage filling and can lid closure.

When the energy curable inkjet ink is applied to the surface of the can body in Step 1 above, it is preferred to be fully LED cured or fully UV cured to reach a surface-tack-free status so the cured can may be conveniently packed up and transferred to the operation unit used in Step 2 where an overprint varnish is immediately applied to the surface of the cured ink. The inkjet ink in Step 1 above should wet the can body well and once cured, should be able to provide strong adhesion to the can surface.

In the beverage can industry, the two-piece can is often coated with a thin layer of base coat (a water-based coating material) prior to printing the ink on the can. This can is also referred to as a “precoated can”. It is said this base coat helps to protect the can surface and offers a better visual quality. However, due to the fact that the base coat contains acrylic/melamine resin and other additives, this type of can may have a relatively low surface energy itself, so the adhesion-related issues are often encountered when the inks are applied to the can body. To get a desired print quality and an acceptable adhesion between the ink layer and base coat layer of the precoated can, the inkjet inks applied should have a lower surface tension. This, however, conflicts with the ink property that is required in Step 2 mentioned above. In Step 2, the surface tension of the inkjet ink should be reasonably high so the overprint varnish can wet the cured ink layer well and form a strong cohesion bond.

Even if the cured ink is able to provide the desirable adhesion properties for the base coat and the overprint varnish applied to the beverage can, the adhesion failure of ink to metal surface and/or the cohesive failure of ink to overprint varnish are still often encountered during pasteurization treatment mentioned in Step 3 above. From this point of view, imparting to the decorated ink the desirable water-resistance, chemical-resistance (such as MEK rub resistance), and the desirable mechanical properties (such as pencil hardness) is another challenge to be overcome by the beverage can industry.

Last, is the increased demand in the beverage can industry for the use of low odor, low extraction inks and coatings. The conventional energy curable inkjet inks are not suited for printing directly on food packaging, as the main components used in this type of ink are mono-functional monomers due to the low viscosity requirement. The mono-functional UV-curable monomers are generally more volatile, and often more odorous. The odors from those monomers are offensive to the press operators. They can persist after curing of the ink film, and even be perceived by the end user of the printed product. For example, they may be perceived by the end user through their lips and/or mouth as they drink from the beverage container.

From a safety and environmental point of view, the energy curable inks/coatings having no odor (or low odor) are useful in the beverage can industry. So far, no such energy curable, inkjetable ink/coating product is available in the beverage can industry. Thus, there remains a need to provide an inkjet ink that has a low odor both at the printing stage and when used by the end user.

### SUMMARY

In one aspect, disclosed is an ink composition including a mono-functional monomer, the mono-functional monomer comprising a hydrophilic mono-functional monomer, a di-functional monomer, an optional colorant, and an optional photoinitiator, wherein a ratio between a weight of the di-functional monomer and a weight of the mono-functional monomer in the ink composition is greater than 0.1.

In another aspect, disclosed is an ink composition including, in percent by weight based on the weight of the total ink composition about 5% to about 35% of a hydrophilic mono-functional monomer, about 30% to about 70% of a di-functional monomer, about 0% to about 4% of a colorant, and an optional photoinitiator, wherein the ink composition has an average double bond density of polymerizable components of greater than 1.5.

In another aspect, disclosed is a method of printing a decoration on a substrate, the method including applying an ink composition to a surface of a substrate, wherein the ink composition includes a mono-functional monomer, the mono-functional monomer comprising a hydrophilic mono-functional monomer, a di-functional monomer, an optional colorant, and an optional photoinitiator, wherein a ratio between a weight of the di-functional monomer and a weight of the mono-functional monomer in the ink composition is greater than 0.1. The method further includes irradiating the ink composition with ultraviolet radiation, light emitting diode radiation, or electron beam radiation to cure the ink composition on the surface of the substrate to provide a decorated substrate.

In another aspect, disclosed is a decorated substrate including a substrate and a cured ink composition derived from an ink composition as disclosed herein on a surface of the substrate.

In another aspect, disclosed is an energy curable inkjet ink composition that fully cures after application to a substrate followed by exposure to LED light, UV light or EB radiation including a mono-functional monomer, a multi-functional monomer, a colorant, and one or more functional materials for regulating the wetting/flow/curing properties of the monomer(s) and colorant(s).

The energy curable inkjet ink composition can have at least one monomer that is a hydrophilic monomer comprising at least one of the hydrophilic groups such as hydroxyl group, amide group, carboxyl group, amino group in its molecular structure. The hydrophilic mono-functional monomers can include 4-hydroxybutyl acrylate (4HBA), diacetone acrylamide (DAAM), 2-[[(butylamino) carbonyl]oxy]ethyl acrylate, 2-hydroxy-3-phenoxypropyl acrylate, O-carboxyethyl acrylate, hydroxyethylcaprolactone acrylate, vinyl methyl oxazolidone (VMOX), or a mixture thereof, at a level of about 3% to about 46% by weight of the total ink composition. The hydrophilic mono-functional monomer, together with other mono-functional monomer(s) can account for about 3% to about 80% by weight of the total ink composition.

At least one of the multi-functional monomers can be a di-functional monomer, at a level of about 10% to about 80% by weight of the total ink composition. The di-functional monomer can include 3-methyl-1,5-pentanediyl diacrylate, propoxylated neopentyl glycol diacrylate, 1,10-decanediol diacrylate, 2-hydroxy 3-methacryl propyl acrylate, dipropylene glycol diacrylate, tripropylene glycol diacrylate, 1,6-hexanediol (2EO) diacrylate, propoxylated hexanediol diacrylate, and 2-(2-vinyloxyethoxy)ethyl acrylate, or a mixture thereof. The multi-functional monomers can further include a tri-functional monomer, at a level of up to about 20% by weight of the total ink composition. The tri-functional monomer can include ethoxylated trimethylolpropane triacrylate (EOTMPTA), propoxylated trimethylolpropane triacrylate (POTMPTA), 2-tris (2-hydroxy ethyl) isocyanurale triacrylate, or a mixture thereof. The multi-functional monomers can further include tetra-, penta- or hexa-functional monomers, at a level of up to about 15% by weight of the total ink composition. The tetra-, penta- or hexa-functional monomer can include pentaerythritol tetraacrylate, ethoxylated pentaerythritol tetraacrylate, dipentaerythritol pentaacrylate, dipentaerythritol hexaacrylate, or a mixture thereof. The ratio (weight/weight) of the di-functional monomer to the mono-functional monomer can be greater than 0.1. The average double bond density of polymerizable components can be greater than 1. The average double bond density of the polymerizable components can be attributed to when the di-functional monomer, tri-functional monomer, high functionality monomer, or a combination thereof are used in the disclosed ink composition.

At least one of the colorants can be a pigment or a dye that is compatible with the monomers and dispersants used in the ink composition, and can form a stable pre-dispersion under proper shearing conditions. The individual colorant for each of the process colors can account for up to about 4% by weight of the total ink composition.

At least one of the functional materials for curing the monomers can be an acylphosphine-oxide-based initiator or a polymeric initiator, at a level of up to about 15% by weight of the total ink composition, when the cure involves the use of LED light or UV light. The acylphosphine-oxide-based initiator can include phenyl bis(2,4,6-trimethylbenzoyl) phosphine oxide (Bapo), the polymeric initiator can include polymeric thioxanthone derivatives (Omnipol™ TX) or/and polymeric aminoalkylphenones (Omnipol 910). The functional materials can further include a synergist, a stabilizer or polymerization inhibitor, a wetting/flow agent, a de-aerator/defoamer, an inert resin, an oligomer, where the inert resin or oligomer can include at least one hydrophilic group such as hydroxyl group, amide group, carboxyl group, amino group in its molecular structure.

The ink composition can have a viscosity of no more than about 40 cPs at about 25° C. and no more than about 15 cps at about 45° C., respectively, and a surface tension of no less than about 20 mN/m and no more than about 27 mN/m at room temperature.

In another aspect, disclosed is a method to perform a substrate decoration including: (a) jetting a disclosed energy curable inkjet ink composition on an optionally precoated substrate (e.g., on a white base can or on a clear coated can); (b) having the inkjet ink LED cured, UV cured or EB cured on a surface of the substrate; (c) having the cured inkjet ink laminated by imprinting a water-based overprint varnish through a roll coat process; and optionally (d) having the imprinted substrate baked at high temperatures (about 350° F. to about 400° F.) to impart to the finished product (e.g., metal beverage can) useful properties such as low migration, chemical resistance and pasteurization resistance.

In another aspect, disclosed is an inkjet ink composition that can be applied to a beverage can through a printhead and provide good adhesion to a can body surface once the ink is cured by radiation sources including LED light, UV light, or the electron beam.

In another aspect, disclosed is an inkjet ink composition that can be overprinted by a water-based clear coat. The combined use of the above inkjet ink and water-based overprint clear coat can provide the finished can with desirable adhesion properties, gloss level, hardness, chemical resistance, and/or pasteurization resistance.

In another aspect, disclosed is an energy curable inkjet ink composition comprising at least a mono-functional monomer, a di-functional monomer, and a colorant.

### BRIEF DESCRIPTION OF THE DRAWINGS

FIG. 1 is an illustration of an example substrate.

FIG. 2 is an illustration of a cross-section of an example finished substrate printed with the disclosed ink compositions.

### DETAILED DESCRIPTION

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the disclosed invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are explicitly contemplated in addition to 6 and 9, for the range 6.0-7.0, the number 6.0, 6.1, 6.2, 6.3, 6.4, 6.5, 6.6, 6.7, 6.8, 6.9, and 7.0 are explicitly contemplated, and for the range 1.5 to 2, the numbers 1.5, 1.6, 1.7, 1.8, 1.9, and 2 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, the term “acrylate” refers to an α,β-unsaturated ester or acid functionality (e.g., H₂C═CHC(O)—O— and H₂C═CRC(O)—O—, wherein R is an alkyl group).

As used herein, “monomer” refers to a material having a viscosity less than that of an oligomer and a relatively low molecular weight (e.g., less than about 1000 g/mole) and containing one or more unsaturated groups (e. g., acrylate group or C═C double bond), which are capable of polymerizing to form oligomers or polymers. A monomer generally has viscosity of 500 cPs or less at 25° C.

As used herein, the term “mono-functional acrylate monomer” refers to a monomer containing one functional acrylate group.

As used herein, the term “di-functional acrylate monomer” refers to a monomer containing two functional acrylate groups.

As used herein, the term “tri-functional acrylate monomer” refers to a monomer containing three functional acrylate groups.

As used herein, the term “high functionality acrylate monomer” refers to an acrylate monomer containing greater than three functional acrylate groups or three C═C double bonds.

As used herein, the terms “(meth) acrylate” and “(meth) acrylic acid” include both acrylate compounds and methacrylate compounds.

As used herein, the term “ethoxylated” refers to chain extended compounds through the use of ethylene oxide.

As used herein, the term “propoxylated” refers to chain extended compounds through the use of propylene oxide.

As used herein, the term “alkoxylated” refers to chain extended compounds using either or both ethylene oxide and propylene oxide.

As used herein, “oligomer” refers to a material having a viscosity greater than that of a monomer and a relatively intermediate molecular weight (e.g., 5,000 g/mole to 200,000 g/mole) and having one or more unsaturated groups, which are capable of polymerizing to form polymers with higher molecular weight.

As used herein, the term “molecular weight” means number average molecular weight unless expressly noted otherwise. Molecular weight can be measured by techniques used within the art, such as size exclusion chromatography, gel permeation chromatography, mass spectrometry, rheometery, and the like.

As used herein, “polymer” refers to a macromolecule that has a molecular structure including a large number of smaller units bonded together. The smaller units are generally coming from monomers or oligomers.

As used herein, the term “inert resin” refers to a resin that contains no double C═C bond or other reactive groups that would allow it to be incorporated into, e.g., a polymer. In the ink composition, it doesn't react with monomers/oligomers regardless of exposure to the energy radiation (e.g., UV, LED, EB) or not.

As used herein, “energy curable” refers to curing in response to exposure to suitable energy sources such as actinic radiation (e.g., ultra violet (UV) radiation and light emitting diode (LED) radiation) and electronic beam radiation.

As used herein, “cure” or “curing” refers to a process that leads to polymerizing, hardening, and/or cross-linking of monomer and/or oligomer units to form a polymer. Curing can occur via any polymerization mechanism initiated by UV, LED, EB or other suitable energy sources.

As used herein, the term “room temperature” refers to an ambient temperature of about 23° C. to about 25° C.

As used herein, the term “coat weight” refers to the amount of an ink or a coating applied to a given side or surface of a substrate. This is usually expressed in grams of the composition per square meter of the substrate (“gsm”).

As used herein, the term “low extraction” refers to the level of contamination of any packaged product produced being less than 50 parts per billion (ppb) of any particular uncured monomers that may leach out of the ink or coating once it is cured on the substrate. ‘Low extraction’ further refers to contamination by photoinitiator residues and decomposition products, which should also be less than 50 ppb, or less than the specific migration limit (SML) existing for a specific photoinitiator.

As used herein, the term “low odor” refers to a less emotional impact persevered when a smelling test is conducted under a specific atmosphere. An odor itself is a volatilized chemical compound, usually at a very low concentration, which humans and other animals perceive by the sense of olfaction. Odor can be measured as described in the Examples.

Provided herein is a low odor, energy curable inkjet ink composition that is capable of being cured, upon the deposition on a substrate (e.g., metal can body, paper-based carton, plastic bottle, etc.) and exposure to LED light, UV light, or EB radiation to an extent that can be surface tack-free and capable of imprinting a layer of water-based overprint varnish, which can impart to the finished substrate the useful adhesion properties, hardness properties, low migration properties, and chemical and pasteurization resistance. The ink composition can also be referred to herein as an inkjet ink composition due to its ability to be applied to a substrate via ink jetting. Accordingly, the ink composition has a viscosity suitable to be ink jetted.

The ink composition can include at least one mono-functional monomer, where the mono-functional monomer can include at least one hydrophilic mono-functional monomer, a di-functional monomer, an optional colorant, and an optional photoinitiator. The ink composition can further include a tri-functional monomer, a high functionality monomer, or a combination thereof. The ink composition can also include at least one functional material that can regulate the wetting/flow/curing properties of the monomer(s) and/or colorant(s).

The amounts of the components for the disclosed ink composition discussed below are in weight percentage (wt %) unless specified otherwise. For example, an embodiment including the mono-functional monomer at greater than 3% by weight of the total ink composition refers to the ink composition including the mono-functional monomer at greater than 3 wt % based on the weight of the total ink composition.

### Mono-Functional Monomers

The mono-functional monomers contain one functional acrylate group. In other words, the mono-functional monomer has one C═C double bond. The mono-functional monomer may also be referred to as a mono-functional acrylate monomer. Examples of mono-functional monomers provided herein include aliphatic mono (meth) acrylate, aromatic mono (meth)acrylate, alkoxylated (meth) acrylate, tetrahydrofurfuryl (meth) acrylate, alkoxylated tetrahydrofurfuryl (meth) acrylate. Mono-functional monomers are available from suppliers such as Sartomer, Allnex, BASF, and Rhan.

The mono-functional monomer can include one or more hydrophobic groups in the molecular structure. The hydrophobic group(s) can impart to the cured ink film flexibility and water-resistance. This type of mono-functional monomer is referred to as a “hydrophobic mono-functional monomer.” The hydrophobic mono-functional monomer also refers to monomers that have a low water solubility, usually less than 0.01 g/L. Examples of hydrophobic mono-functional monomers include octyl (meth)acrylate, lauryl (meth)acrylate, tridecyl (meth) acrylate, stearyl (meth)acrylate, decyl (meth)acrylate, isodecyl (meth)acrylate, iso-octyl (meth)acrylate, and o-phenyl phenoxyethyl acrylate. Lauryl acrylate (SR-335, Mt. 240, Tg-30° C., viscosity 6 cPs, surface tension 30.3 mN/m from Sartomer), isooctyl acrylate (SR-440, Mt.184, Tg−54° C., viscosity 5 cps, surface tension 28 mN/m from Sartomer), tricyclodecanemethanol acrylate (SR-789, Mt. 220, Tg 35° C., viscosity 15 cPs from Sartomer), cyclic trimethylolpropane formal acrylate (SR-531, Mt. 200, Tg 10° C., viscosity 15 cPs, surface tension 33 mN/m from Sartomer), phenol [4 EO] acrylate (Photomer 4039, Mt. 280, Tg 12° C., viscosity 30 cPs, surface tension 40.7 mN/m from IGM), tripropyleneglycol monomethyl ether acrylate (TPGMEMA, Photomer 8061, Mt. 260, viscosity 7 cPs, surface tension 31 mN/m from IGM) and o-phenyl phenoxyethyl acrylate (EM2105, Mt. 268, Tg 107° C., viscosity 135 cPs from Eternal) are examples of exemplary hydrophobic mono-functional monomers.

The mono-functional monomer can include one or more hydrophilic groups in the molecular structure. It has been found that the mono-functional monomer in the disclosed ink compositions containing a least one hydrophilic mono-functional monomer can regulate the wetting ability of energy curable digital ink to the substrate surface and can regulate the imprint-ability of the energy curable digital ink to the water-based overprint clear coating. The “hydrophilic mono-functional monomer” refers to mono-functional monomers that have a relatively high “water-solubility” where the solubility is generally imparted by a hydroxyl group, an amide group, a carboxyl group, an amino group, or another polar group in its molecular structure. Accordingly, in some embodiments, the hydrophilic mono-functional monomer includes at least one polar group. In some embodiments, the hydrophilic mono-functional monomer includes at least one hydroxyl group, amide group, carboxyl group, or amino group, or a combination thereof. In some embodiments, the hydrophilic mono-functional monomer includes at least one hydroxyl group, amide group, carboxyl group, or amino group.

This type of “water-solubility” (sometimes also expressed as “water wettability” or “hydrophilicity”) may also come from a polar group attached to di-functional monomers, tri-functional monomers, tetra-functional monomers, penta-functional monomers, hexa-functional monomers, inert resins, and oligomers in the ink compositions. The hydrophilic components of the present disclosure, however, are preferably to be those that possess relatively low molecular weight and relatively low viscosity. In some embodiments, the hydrophilic component of the ink composition is derived from the mono-functional monomer. In some embodiments, the hydrophilic component of the ink composition is only derived from the mono-functional monomer. In some embodiments, the hydrophilic component of the ink composition is not derived from di-functional monomers, tri-functional monomers, tetra-functional monomers, penta-functional monomers, hexa-functional monomers, inert resins, and/or oligomers.

Examples of hydrophilic mono-functional monomers include hydroxyl (meth)acrylate such as 4-hydroxybutyl acrylate (4HBA, Mt. 144, Tg −40° C., viscosity 11 cPs, surface tension 35.0 mN/m from BASF) and 2-hydroxy-3-phenoxypropyl acrylate (CN-131B, Mt. 222, Tg 13° C., viscosity 250 cPs from Sartomer), (meth)acrymide such as diacetone acrylamide (DAAM, Mt. 229, Tg 77° C., viscosity 18 cPs, surface tension 30.6 mN/m from KH Neochem), (meth)acrylic such as acrylic acid (AA, Mt. 72, viscosity 1.3 cPs, Tg 374° C., surface tension 28.1 mN/m from BASF), vinyl compounds such as N-vinylpyrrolidone (NVP, Mt. 111, viscosity 2.5 cPs, Tg 150° C., surface tension 32.5 mN/m from Ashland), N-vinyl caprolactam (NVC, Mt. 139, viscosity 5 cPs, Tg 147° C., surface tension 43.9 mN/m from Ashland) and vinyl methyl oxazolidone (VMOX, Mt. 127, viscosity 4 cPs from BASF), acryloylmorpholine compounds such as 4-acryloylmorpholine (ACMO, Mt. 141, viscosity 12 cPs, Tg 145° C., surface tension 45 mN/m from BASF), caprolactone compounds such as caprolactone acrylate (SR-495, Mt. 186, viscosity 80 cPs, Tg −53° C., surface tension 42.95 mN/m from Sartomer) and the caprolactone condensation product (Photomer 4034, Mt. 334, viscosity 80 cPs from IGM).

The ink composition can include a combination of the hydrophobic mono-functional monomer and the hydrophilic mono-functional monomer. The type and the ratio of the hydrophobic component to the hydrophilic component can play a role in imparting the final properties of an amphiphilic copolymer formed through the energy curing reactions. The properties of the amphiphilic copolymer can regulate the wetting ability of the ink to substrate surface and can also regulate the recoat-ability of a cured ink with a water-based overprint clear.

The hydrophobic monomer(s) and the hydrophilic monomer(s) can be used in any ratio so long as they are compatible with each other and are able to form a uniform solution in the inkjet ink system. Dependent upon the chemical category of the hydrophilic monomers applied, the hydrophilic monomer(s) can account for as low as about 3% of the total weight of the inkjet ink composition, or as high as about 46% of the total weight of the inkjet ink composition. Accordingly, in some embodiments, the ink composition includes the hydrophilic mono-functional monomer at about 3% to about 46% by weight of the total ink composition, such as about 3% to about 42%, about 5% to about 40%, about 10% to about 35%, about 10% to about 40%, about 15% to about 35%, about 5% to about 30%, about 10% to about 25%, about 3% to about 12%, about 5% to about 15%, about 15% to about 46%, about 20% to about 45%, or about 18% to about 32% by weight of the total ink composition. In some embodiments, the ink composition includes the hydrophilic mono-functional monomer at greater than 3%, greater than 5%, greater than 10%, greater than 15%, or greater than 20% by weight of the total ink composition. In some embodiments, the ink composition includes the hydrophilic mono-functional monomer at less than 46%, less than 40%, less than 35%, less than 30%, or less than 25% by weight of the total ink composition.

The hydrophilic mono-functional monomer can make up varying amounts of the total mono-functional monomer present in the ink composition. For example, the mono-functional monomer can include the hydrophilic mono-functional monomer at about 50% to about 100% by weight of the mono-functional monomer, such as about 55% to about 100%, about 60% to about 100%, about 50% to about 95%, about 75% to about 100%, about 80% to about 100%, or about 90% to about 100% by weight of the mono-functional monomer. In some embodiments, the mono-functional monomer includes the hydrophilic mono-functional monomer at greater than 50%, greater than 60%, greater than 70%, greater than 80%, greater than 85%, greater than 90%, or greater than 95% by weight of the mono-functional monomer. In some embodiments, the hydrophilic mono-functional monomer makes up about 100%, by weight, of the monofunctional monomer.

The ink composition can include the hydrophobic mono-functional monomer at about 0% to about 77% by weight of the total ink composition, such as about 1% to about 77%, about 1% to about 70%, about 10% to about 60%, about 15% to about 55%, about 25% to about 77%, about 50% to about 77%, about 1% to about 50%, about 5% to about 75%, about 40% to about 75%, about 20% to about 65%, about 1% to about 25%, about 0.5% to about 20%, about 1% to about 10%, about 0.5% to about 15%, about 0.1% to about 12%, about 2% to about 15%, or about 5% to about 12% by weight of the total ink composition. In some embodiments, the ink composition includes the hydrophobic mono-functional monomer at greater than 0%, greater than 0.1%, greater than 0.5%, greater than 1%, greater than 2%, greater than 3%, greater than 4%, greater than 5%, greater than 10%, greater than 20%, greater than 30%, greater than 40%, greater than 50%, greater than 60%, or greater than 70% based by weight of the total ink composition. In some embodiments, the ink composition includes the hydrophobic mono-functional monomer at less than 77%, less than 70%, less than 60%, less than 50%, less than 40%, less than 30%, less than 25%, less than 20%, less than 15%, less than 12%, or less than 10% by weight of the total ink composition. In some embodiments, the hydrophobic mono-functional monomer is present in the ink composition at a weight amount that is lower than the hydrophilic mono-functional monomer. In some embodiments, the ink composition does not include a hydrophobic mono-functional monomer.

Some mono-functional monomers are known to have a high and unpleasant odor. This type of mono-functional monomer is limited or eliminated in the disclosed ink compositions. Examples of mono-functional monomers having an unpleasant odor include benzyl acrylate, 2-propyl heptyl acrylate, 2-methoxy ethyl acrylate, tetrahydrofurfuryl acrylate, dicyclopentyl acrylate, dicyclopentenyloxyethyl acrylate, dicyclopentanyl acrylate and dihydrocyclopentadienyl acrylate. In some embodiments, the ink composition does not include the aforementioned mono-functional monomers (individually or any combination thereof) with an associated unpleasant odor.

Other mono-functional monomers known to have an adverse effect on odor or carry an adverse product labeling are also limited or eliminated in the disclosed ink compositions. Examples of these type of mono-functional monomers include 2-phenoxyethyl acrylate, isobornyl acrylate, t-butyl cyclohexyl acrylate, 3,3,5-trimethyl cyclohexyl acrylate, 2-hydroxyethyl acrylate (HEA), 2-ethoxyethoxyethyl acrylate (EOEOE), N-vinyl caprolactam (NVC), and N-Vinyl-pyrrolidone (NVP). In some embodiments, the ink composition does not include the aforementioned mono-functional monomers (individually or any combination thereof) with an associated adverse effect on odor or carry an adverse product labeling.

The mono-functional monomer may be solely used (e.g., one type of mono-functional monomer is used in the ink composition), or two or more mono-functional monomers may be used in combination. The total mono-functional monomer composition present in the inkjet ink composition can be about 3% to about 80% by weight of the total ink composition, such as about 2% to about 55%, about 10% to about 40%, about 15% to about 35%, about 20% to about 50%, about 30% to about 60%, about 5% to about 70%, about 10% to about 65%, about 15% to about 40%, about 20% to about 45%, or about 15% to about 45% by weight of the total ink composition. In some embodiments, the total mono-functional monomer composition present in the inkjet ink composition is greater than 3%, greater than 5%, greater than 10%, greater than 15%, greater than 20%, greater than 25%, greater than 30%, greater than 35%, greater than 40%, or greater than 45% by weight of the total ink composition. In some embodiments, the total mono-functional monomer composition present in the inkjet ink composition is lower than 80%, lower than 75%, lower than 70%, lower than 65%, lower than 60%, lower than 55%, lower than 50%, lower than 45%, lower than 40%, lower than 35%, or lower than 30% by weight of the total ink composition.

### Di-Functional Monomers

The di-functional monomers contain two functional acrylate groups. In other words, the di-functional monomer has two C═C double bonds. The di-functional monomer may also be referred to as a di-functional acrylate monomer. They generally have a lower odor and cure faster than the mono-functional monomers. Examples of di-functional monomers include aliphatic di-(meth) acrylate, aromatic di-(meth)acrylate, alkoxylated aliphatic di-(meth)acrylate, alkoxylated aromatic di-(meth) acrylate, glycol di-(meth)acrylate, and cyclohexane dimethanol di-(meth)acrylate. Di-functional monomers are available from suppliers such as Sartomer, Allnex, BASF, and Rhan.

Exemplary di-functional monomers include 3-methyl-1.5-pentanediol diacrylate (MPDDA, SR341 Mt. 226, Tg 50° C., viscosity 8.5 cPs, surface tension 33 mN/m from Sartomer), 1,10-decanediol diacrylate (CD-595, Mt. 282, viscosity 15 cPs, Tg 91° C., surface tension 33.4 mN/m from Sartomer), propoxylated neopentyl glycol diacrylate (SR9003B, Mt. 212, Tg 32° C., viscosity 15 cPs, surface tension 32 mN/m from Sartomer), 1,6-hexanediol (2EO) diacrylate (Photomer 4361, EOHDDA, Mt. 314, viscosity 15 cPs, surface tension 37.5 mN/m from IGM), propoxylated hexanediol diacrylate (Photomer 4362, Mt. 342, viscosity 10-20 cPs, surface tension 34.4 mN/m from IGM), 2-hydroxy 3-methacryl propyl acrylate (NK ESTETR 701A, Mt. 214, viscosity 44 cPs from Shin-Nakamura Chemical Co. Ltd), dipropylene glycol diacrylate (DPGDA, SR 508, Mt. 242, viscosity 10 cPs, Tg 104° C., surface tension 33 MN/m from Sartomer), and tripropylene glycol diacrylate (TRPGDA, SR306, Mt. 300, viscosity 15 cPs, Tg 62° C. surface tension 33 mN/m from Sartomer) and 2-(2-Vinyloxyethoxy)ethyl acrylate (VEEA, Mt.186, viscosity 3.6 cPs from Nippon Shokubai).

The di-functional monomer may be solely used, or two or more of di-functional monomers may be used in combination. The total di-functional monomer composition present in the total inkjet ink composition can be about 10% to about 80%, such as about 20% to about 70%, about 40% to about 60%, about 15% to about 75%, about 20% to about 60%, about 25% to about 65%, about 25% to about 60%, about 30% to about 65%, or about 35% to about 55% based on the weight of the total ink composition. In some embodiments, the total di-functional monomer composition present in the total inkjet ink composition is greater than 10%, greater than 15%, greater than 20%, greater than 25%, greater than 30%, greater than 35%, greater than 40%, or greater than 50% based on the weight of the total ink composition. In some embodiments, the total di-functional monomer composition present in the total inkjet ink composition is less than 80%, less than 75%, less than 70%, less than 65%, less than 60%, less than 55%, or less than 50% based on the weight of the total ink composition.

The relationship between the di-functional monomer and the mono-functional monomer can be used to provide useful benefits to the ink compositions and cured ink compositions thereof. For example, it has been found that the ratio of di-functional monomer to mono-functional monomer can be used to provide beneficial ink performance properties (e.g., cross-hatch adhesion, MEK resistance, pencil hardness, and pasteurization). The ratio of the weight of the di-functional monomer to the weight of the mono-functional monomer can be greater than 0.1, greater than 0.2, greater than 0.3, greater than 0.4, greater than 0.5, greater than 0.6, greater than 0.7, greater than 0.8, greater than 0.9, greater than 1, greater than 1.1, greater than 1.2, greater than 1.3, greater than 1.4, greater than 1.5, greater than 1.6, greater than 1.7, greater than 1.8, greater than 1.9, or greater than 2. In some embodiments, the ratio (weight/weight) of the di-functional monomer to the mono-functional monomer is less than 3, less than 2.8, less than 2.7, less than 2.6, less than 2.5, less than 2.4, less than 2.3, less than 2.2, less than 2.1, or less than 2. In some embodiments, the ratio (weight/weight) of the di-functional monomer to the mono-functional monomer is about 0.1 to about 3, such as about 0.1 to about 2.5, about 0.4 to about 2.6, about 0.5 to about 2.5, about 1 to about 2.5, about 1.5 to about 2.5, about 0.1 to about 2, about 0.7 to about 2.7, about 0.8 to about 2.6, about 1 to about 2.4, about 1.5 to about 2.2, about 1.7 to about 2.5, about 1.8 to about 2.1, about 1.2 to about 2.4, about 0.6 to about 1.6, about 0.7 to about 1.5, about 0.8 to about 1.4, or about 0.9 to about 1.2.

It has also been found that the average double bond density of the ink composition can be used to provide beneficial ink performance properties (e.g., cross-hatch adhesion, MEK resistance, pencil hardness, and pasteurization). Average double bond density (or average functionality) of polymerizable components=(1×mole number of mono-functional component+2×mole number of di-functional component+3×mole number of tri-functional component+ . . . )/total mole number of polymerizable components (or total mole number of un-saturated components). Further description on average double bond density as used herein can be found in the Examples.

The average double bond density of polymerizable components can be greater than 1, greater than 1.1, greater than 1.2, greater than 1.3, greater than 1.4, greater than 1.5, greater than 1.6, greater than 1.7, greater than 1.8, or greater than 1.9. In some embodiments, the average double bond density of polymerizable components is no greater than 2. In some embodiments, the average double bond density of polymerizable components is less than 2, less than 1.9, less than 1.8, less than 1.7, less than 1.6, less than 1.5, less than 1.4, less than 1.3, less than 1.2, or less than 1.1. In some embodiments, the average double bond density of polymerizable components is about 1 to about 2, such as about 1 to about 1.9, about 1.1 to about 2, about 1.2 to about 2, about 1 to about 1.8, about 1.2 to about 1.8, about 1.3 to about 1.7, about 1.4 to about 1.6, about 1.1 to about 1.9, or about 1.3 to about 2. The average double bond density of the polymerizable components can be attributed to when the di-functional monomer, tri-functional monomer, high functionality monomer, or a combination thereof are used in the disclosed ink composition.

### Tri-Functional Monomers

The tri-functional monomers contain three functional acrylate groups. In other words, the tri-functional monomer has three C═C double bonds. The tri-functional monomer may also be referred to as a tri-functional acrylate monomer. They generally have a lower odor and cure faster than the di-functional monomers. Examples of tri-functional monomers include trimethylolpropane tri(meth)acrylate and alkoxylated trimethylolpropane tri(meth)acrylate. For low ink viscosity, fast cure, low odor, and low extraction purposes, tri-functional monomer can be alkoxylated and have a viscosity of lower than 200 cPs, such as lower than 100 cPs at about 25° C.

Ethoxylated (3) trimethylolpropane triacrylate (EO3TMPTA, SR454, Mt. 429, Tg 103° C., viscosity 110 cPs, surface tension 40 mN/m from Sartomer), propoxylated trimethylolpropane triacrylate (POTMPTA, SR492, Mt. 470, Tg −15° C., viscosity 90 cPs, surface tension 34 mN/m from Sartomer), and 2-tris (2-hydroxy ethyl) isocyanurale triacrylate (SR368D, Mt. 375, Tg 61° C., viscosity 33 cps, surface tension 37 mN/m from Sartomer) are examples of exemplary tri-functional monomers.

The tri-functional monomer may be solely used, or two or more tri-functional monomers may be used in combination. The total tri-functional monomer composition present in the inkjet ink composition can be about 0% to about 20% based on the weight of the total ink composition, such as about 1% to about 20%, about 1% to about 15%, about 1% to about 10%, about 2% to about 18%, about 4% to about 16%, about 3% to about 15%, about 5% to about 10%, about 1% to about 5%, about 2% to about 8%, about 10% to about 20%, about 15% to about 20%, or about 8% to about 12% based on the weight of the total ink composition. In some embodiments, the total tri-functional monomer composition present in the inkjet ink composition is greater than 0%, greater than 1%, greater than 2%, greater than 3%, greater than 4%, greater than 5%, greater than 6%, greater than 7%, greater than 8%, greater than 9%, or greater than 10% based on the weight of the total ink composition. In some embodiments, the total tri-functional monomer composition present in the inkjet ink composition is less than 20%, less than 19%, less than 18%, less than 17%, less than 16%, less than 15%, less than 14%, less than 13%, less than 12%, less than 11%, or less than 10% based on the weight of the total ink composition.

### High Functionality Monomers

High functional acrylate monomer refers to an acrylate monomer containing greater than three functional acrylate groups. Examples of high functional monomers include pentaerythritol tetraacrylate, di-trimethylolpropane tetraacrylate, dipentaerythritol pentaacrylate, and dipentaerythritol hexaacrylate. The use of high functionality monomers can provide fast curing and increase the extent of crosslinking. For low ink viscosity, fast cure, and flexibility purposes, the high functional monomer can have a viscosity of lower than about 7000 cPs, such as lower than about 500 cPs at about 25° C.

Pentaerythritol tetraacrylate (SR295, Mt. 352, viscosity 342 cps), ethoxylated pentaerythritol tetraacrylate (SR494, Mt. 528, viscosity 150 cps), dipentaerythritol pentaacrylate (SR399LV, Mt. 524, viscosity 7000 cPs) supplied by Sartomer and dipentaerythritol hexaacrylate (DPHA, Miramer 600, Mt. 580, viscosity 4000) supplied by Miwon are examples of exemplary high functional monomers.

The high functional monomers may be solely used, or two or more of high functional monomers may be used in combination. The total high functional monomer composition present in the inkjet ink composition can be about 0% to about 15%, such as about 1% to about 15%, about 2% to about 14%, about 3% to about 12%, about 1% to about 5%, about 2% to about 7%, about 1% to about 10%, about 10% to about 15%, about 6% to about 12%, or about 5% to about 10% based on the weight of the total ink composition. In some embodiments, the total high functional monomer composition present in the inkjet ink composition is greater than 0%, greater than 1%, greater than 2%, greater than 3%, greater than 4%, greater than 5%, greater than 6%, or greater than 7% based on the weight of the total ink composition. In some embodiments, the total high functional monomer composition present in the inkjet ink composition is less than 15%, less than 14%, less than 13%, less than 12%, less than 11%, less than 10%, or less than 9% based on the weight of the total ink composition.

### Colorants

The energy curable inkjet ink composition can be a clear UV curable, LED curable, or EB curable ink composition. But for beverage and food container application, the ink composition can also include at least one colorant. The colorant can be a dye or a pigment. In some embodiments, the colorant is a pigment.

The pigment may be cyan, magenta, yellow, black, white, red, orange, violet, blue, green, brown, or a mixture thereof. Examples of the pigments can be grouped in the corresponding color index:

Pigment Yellow 1, 3, 5, 12, 13, 14, 15, 17, 34, 35, 37, 41, 42, 43, 55, 74, 81, 83, 87, 93, 94, 95, 97, 108, 109, 110, 117, 119, 138, 139, 153, 154, 155, 157, 166, 167, 168, 174, 175, 180, 185, 193, 213, 214, and 215;

Pigment Red 3, 5, 19, 22, 23, 31, 38, 41, 43, 48:1, 48:2, 48:3, 48:4, 48:5, 49:1, 52, 52:1, 52:2, 53:1, 57:1, 57:2, 58:4, 63:1, 64:1, 81, 81:1, 81:2, 81:3, 81:4, 88, 95, 104, 108, 112, 122, 123, 136, 144, 146, 149, 166, 168, 169, 170, 175, 177, 178, 179, 184, 185, 208, 216, 226, 254, 257, and 279;

Pigment Blue 1, 15, 15:1, 15:2, 15:3, 15:4, 15:6, 16, 17:1, 22, 24, 24:1, 27, 28, 29, 36, 60, 61, 62, 63, and 75;

Pigment Black 7, 9, 10, 28, and 34;

Pigment White 6, 11, 12, 18, 21, and 22;

Pigment Orange 4, 5, 13, 16, 20, 34, 36, and 64;

Pigment Violet 1, 2, 3, 19, 23, 25, 27, 29, 30, 37, and 50;

Pigment Green 7, 8, 10, 17, 26, and 36; and

Pigment Brown 3, 5, 25, and 26.

Of the above, exemplary pigments include Yellow 185, Red 122, Blue 15:4, Black 7, White 6, Green 7, Orange 64, Violet 23, and Brown 25. These pigments can meet the low viscosity, good dispersibility, good weathering, and color reproducibility of the disclosed ink compositions.

The colorant loading can be about 0% to about 4% based on the weight of the total ink composition, such as about 1% to about 3%, 0.5% to about 4%, about 1% to about 4%, or about 1.5% to about 3.5% based on the weight of the total ink composition. In some embodiments, the colorant is present in the ink composition at greater than 0%, greater than 0.5%, greater than 0.75%, greater than 1%, greater than 1.5%, greater than 1.75%, greater than 2%, or greater than 2.25% based on the weight of the total ink composition. In some embodiments, the colorant is present in the ink composition at less than 4%, less than 3.75%, less than 3.5%, less than 3.25%, less than 3%, less than 2.75%, less than 2.5%, or less than 2% based on the weight of the total ink composition.

Exemplary colorants include TCY18501L (pigment yellow PY185) from Trust Chem., Cinquasia® Magenta D 4545 J (pigment magenta PR122) from BASF, Heliogen® Blue D 7110 (pigment blue PB 15:4) from BASF, and Printex® 27 (black pigment PK-7) from Orion Engineered Carbons.

For convenience in the ink preparation, the colorants can be pre-dispersed with suitable monomers and suitable dispersants to form stable colorant dispersions. The use of dispersant (especially the use of polymeric dispersants) not only can improve the dispersibility of the colorant but can also improve the stability of the final ink. Commercially available polymeric dispersants include ByK-168, Byk-162, Byk-163, Byk-9151, Byk-9152 from Byk, Solsperse 39000, Solsperse 35000, Solsperse 32000, Solsperse 36000 from Noveon, EFKA PX 4701 and EFKA PX 4702 from BASF. In some embodiments, the colorant is dispersed in a polymeric dispersant.

The dispersant loading in the pigment dispersion can be about 1% to about 25% based on the weight of the total dispersion (e.g., weight of the colorant+weight of the dispersant+weight of the monomer), such as about 2% to about 22%, about 4% to about 15%, about 1% to about 10%, about 10% to about 25%, or about 5% to about 20% based on the weight of the dispersion. In some embodiments, the dispersant loading in the pigment dispersion is greater than 1%, greater than 5%, or greater than 10% based on the weight of the dispersion. In some embodiments, the dispersant loading in the pigment dispersion is less than 25%, less than 20%, or less than 15% based on the weight of the dispersion.

BYKJET 9152 from Byk and EFKA PX4701 from BASF are exemplary polymeric dispersants.

### Functional Materials

The ink composition can include a functional material(s). Functional materials include photoinitiators, inert resins, oligomers, synergists, stabilizers, wetting/flow agents, and de-foamers. In some embodiments, the ink composition includes an inert resin, an oligomer, a synergist, a stabilizer, a wetting/flow agent, a de-foamers, or a combination thereof. In some embodiments, the ink composition includes a synergist, a stabilizer, a flow agent, or a combination thereof.

### Photoinitiators

The photoinitiators used in LED curable inkjet ink compositions can absorb longer actinic wave bands that are emitted by the LED lamp (e.g., 395 nm, 365 nm).

The photoinitiators used in UV curable inkjet ink compositions can absorb a wide range of actinic wave bands that are generated by the conventional mercury UV lamp (e.g, from 220 nm to 410 nm).

For an EB curable inkjet ink, there is no need for the use of photoinitiators.

Exemplary photoinitiators include phenyl (trimethylbenzoyl) phosphine oxide, difunctional and oligomeric hydroxyl ketone types. Commercially available products include Omnirad 380, Esacure KIP160 and Irgacure 127 from IGM.

The use of polymeric photoinitiators, such as polymeric benzophenone derivatives, polymeric aminobenzoates, polymeric thioxanthone derivatives, polymeric a-hydroxy ketone can help deliver low extraction properties to the energy curable inkjet ink composition. Commercially available products include the polymeric benzophenone derivatives GENOPOL BP-1 from Rahn and Omnipol BP from IGM, the polymeric aminobenzoates GENOPOL AB-1 from Rahn and Omnipol ASA from IGM, the polymeric thioxanthone derivatives GENOPOL TX-1 from Rahn and Omnipol TX from IGM, the polymeric a-hydroxy ketone Chivacure 150 and Chivacure 70 from Chitec, JR1251 from JIURI, PRO22669 and Speedcure XKm from Sartomer, and Omnipol 910 from IGM, a polymeric photoinitiator, based on the compound of aminoalkylphenone.

The amount of photoinitiator present in the ink composition is generally less than about 15% based on the weight of the total ink composition. In some embodiments, the amount of photoinitiator present in the ink composition is less than 15%, less than 14%, less than 13%, less than 12%, less than 11%, less than 10%, less than 9%, or less than 8% based on the weight of the total ink composition. In some embodiments, the amount of photoinitiator present in the ink composition is greater than 0.5%, greater than 1%, greater than 2%, greater than 3%, greater than 4%, greater than 5%, or greater than 6% based on the weight of the total ink composition. In some embodiments, the amount of photoinitiator present in the ink composition is about 0% to about 15% based on the weight of the total ink composition, such as about 1% to about 10%, about 2% to about 12%, about 3% to about 9%, or about 4% to about 10% based on the weight of the total ink composition.

Omnirad 819, Bis[2,4,6-trimethylbenzoyl] phenyl phosphine oxide, Omnipol 910 and Omnipol TX from IGM are exemplary photoinitiators.

### Inert Resins

Inert resins can be used to provide flexibility and can reduce film shrinkage during the energy curing process as they do not react with the monomers or oligomers (e.g., as in they are not incorporated into polymer chains). Acrylic resins, acrylate resins, methacrylate resins, aldehyde resins, vinyl resins, rosin ester resins, cellulose resin, and hydrocarbon resins can be used in inkjet ink compositions. Exemplary inert resins include thermoplastic resins having glass transition temperature (Tg) of about −20° C. to about 250° C., such as about 10° C. to about 100° C. or about 20° C. to 90° C., and having a molecular weight of about 800 g/mole to about 200,000 g/mole, such as about 7,000 g/mole to about 80,000 g/mole or about 10,000 g/mole to about 60,000 g/mole.

TEGO® VariPlus SK resin (Tg 90° C., hydroxy value 325 mg KOH/g) from Evonic, Laropal A81 resin (Tg 57° C., hydroxy value 40 mg KOH/g) from BASF, and Elvacite 4402 (Mt 40,000, Tg 76° C.) from Lucite are exemplary inert resins in the ink compositions.

The inert resin may be solely used, or two or more inert resins may be used in combination. The total inert resin composition present in the ink composition can be about 0% to about 15% based on the weight of the total ink composition, such as about 1% to about 15%, about 1% to about 10%, or about 2% to about 5% based on the weight of the total ink composition. In some embodiments, the total inert resin composition present in the total ink composition is greater than 0%, greater than 1%, greater than 2%, greater than 3%, greater than 4%, or greater than 5% based on the weight of the total ink composition. In some embodiments, the total inert resin composition present in the ink composition is less than 15%, less than 12%, less than 10%, or less than 8% based on the weight of the total ink composition.

### Oligomers

Oligomers can improve curing speed and can play a similar role to those as the inert resins. The oligomer can include epoxy (meth)acrylate, polyester (meth)acrylate, polyether (meth)acrylate, and polyurethane (meth) acrylate. Exemplary oligomers have a low viscosity and a glass transition temperature (Tg) of about −95° C. to about 175° C., such as about −10° C. to about 100° C., or about 10° C. to about 80° C.

Exemplary oligomers include CN-2302 (Tg 74° C., viscosity 300 cPs), CN147 (Tg 18° C., viscosity 115 cPs) from Sartomer, Laromer P08967 (viscosity 120 cPs) from BASF, Genomer 1122 (Mt. 215) from RAHN, Photomer 6210 (Tg 32° C.), Photomer 4704 (Viscosity 150 cPs) from IGM, and Miramer SC6640 (acid value 240-270 mg KOH/g, viscosity 200 cPs) from Miwon.

The oligomer may be solely used, or two or more oligomers may be used in combination. The total oligomer composition present in the ink composition can be about 0% to about 15% based on the weight of the total ink composition, such as about 1% to about 15%, about 2% to about 12%, about 1% to about 10%, or about 2% to about 5% based on the weight of the total ink composition. In some embodiments, the total oligomer composition present in the ink composition is greater than 0%, greater than 1%, greater than 2%, greater than 3%, greater than 4%, or greater than 5% based on the weight of the total ink composition. In some embodiments, the total oligomer composition present in the ink composition is less than 20%, less than 15%, less than 12%, less than 10%, less than 9%, less than 8%, less than 7%, or less than 6% based on the weight of the total ink composition.

### Synergists

The use of a synergist in the energy curing process can reduce the oxygen inhibition to the photopolymerization and can thus improve the curing speed.

Suitable synergists for the use in low extraction, energy curable (UV curable, LED curable, or EB curable) inkjet ink compositions include an acrylate amine synergist or a polymeric amine synergist. Commercially available acrylate amine synergist products include Ebecryl 115 and Ebecryl p116 from Allnex; CN3715 from Sartomer; Laromer PO 94F from BASF, LED03 from Allnex, Genomer 5161 from Rahn, and Etercure 6328 from Eternal. Commercially available polymeric amine synergist products include Omnipol ASA, Omnipol SZ from IGM, and GENOPOL AB-1 from Rahn.

The synergists described above can be incorporated into the ink composition at about 0% to about 20% based on the weight of the total ink composition, such as about 2% to about 15%, 1% to about 20%, about 3% to about 15%, about 3% to about 10%, or about 4% to about 8% based on the weight of the total ink composition. In some embodiments, the synergist is incorporated into the ink composition at greater than 0%, greater than 1%, greater than 2%, or greater than 4% based on the weight of the total ink composition. In some embodiments, the synergist is incorporated into the ink composition at less than 20%, less than 15%, less than 12%, less than 10%, less than 9%, less than 8%, less than 7%, or less than 6% based on the weight of the total ink composition.

Mono-functional amine CN3175 from Sartomer and di-functional amine Etercure 6328 from Eternal are exemplary synergists in the ink compositions.

### Stabilizers/Polymerization Inhibitors

The energy curable, ink composition can include one or more polymerization inhibitors or stabilizers that can prevent the ink from agglomerating and gelling, or can reduce/eliminate surface cracking of the cured film. Examples of inhibitors include phenolic materials (e.g., benzoquinone, hydroquinone, hydroquinone monomethyl ether, butylated hydroxytoluene), phenothiazines, nitrosophenyl hydroxylamine aluminium salts, benzotriazolealuminium salt amine complexes, and aromatic ammine, nitroxyl compounds. Commercially available stabilizers include Genorad-26 from Nahn, FlorstabUV-1, UV-2, UV-5 from Kromachem LTD, IrgastabUV-10 and Irgastab UV-22 from BASF.

Polymerization inhibitors or stabilizers may be solely used, or two or more of them may be used in combination, in an amount of about 0.05% to about 3% by weight of the total ink composition, such as about 0.1% to about 2.75%, about 0.5% to about 3%, about 1% to about 3%, about 0.5% to about 2.5%, or about 1.5% to about 3% by weight of the total ink composition. In some embodiments, the polymerization inhibitor or stabilizer is present in the ink composition at greater than 0.05%, greater than 0.1%, or greater than 1% by weight of the total ink composition. In some embodiments, the polymerization inhibitor or stabilizer is present in the ink composition at less than 3%, less than 2.5%, or less than 2% by weight of the total ink composition.

Genorad-26 from Rahn, UV-5 from Kromachem Ltd, and UV22 from BASF are exemplary polymerization inhibitors in the ink compositions.

### Wetting/Flow Agents

Wetting/flow agents can be included in the inkjet ink composition to modify surface tension and control the flow/levelling properties. This can ensure the substrate is wetted properly and the ink flows/levelling well when it is applied to the substrate. The wetting/flow agents may come in a silicone-free type (e.g., acrylate polymer) or in a silicone-containing type (e.g., polyether modified polydimethylsiloxane). Commercially available materials include Tego 2200, Tego 2250, Tego glide 410 from Evonic, Byk-377, Byk-333, Byk-315N, Byk361N, UV3500, and UV3510 from Byk, and Ebecryl 350, Ebecryl 1360 from Allnex.

Wetting/flow agents may be solely used, or two or more of them may be used in combination, in the amount of about 0.01% to about 1.5% based on the weight of the total ink composition, such as about 0.05% to about 1.25%, about 0.75% to about 1%, about 0.05% to about 1%, about 0.01% to about 0.5%, or about 0.10% to about 0.50% based on the weight of the total ink composition. In some embodiments, the wetting/flow agent is present in the ink composition at greater than 0.01%, greater than 0.05%, or greater than 0.1% based on the weight of the total ink composition. In some embodiments, the wetting/flow agent is present in the ink composition at less than 1.5%, less than 1%, or less than 0.5% based on the weight of the total ink composition.

Byk333, Byk377 from BYK and Ebecryl 1360 from Allnex are exemplary wetting/flow agent in the ink compositions.

Wetting/flow agents can aid in the inkjet ink compositions having the desired adhesion properties to the substrate when cured by a LED, UV, or EB radiation. Proper control of the curing of the ink composition by, e.g., adjusting the type and ratio of hydrophilic polymerizable component(s) to hydrophobic polymerizable component(s) can allow the cured ink to be imprintable when the water-based overprint clear is applied to the ink layer deposited on the substrate (e.g., metal can surface, surface of a paper-based carton, surface of a plastic bottle, etc.).

### De-Aerators/Defoamers

Proper foam mitigating or foam destroying materials can be included in the inkjet ink composition as a de-aerator, and/or a defoamer. Examples of de-aerators/defoamers include polyacrylates, polyglycols, polyols, polysiloxanes, oxyalkylene amines, silicone oils and fluids, and polyether modified methylalkyl polysiloxane copolymers, and combinations thereof.

The de-aerators can prevent the formation of air inclusions and pinholes in the cured ink. Examples of the de-aerators include TEGO 920 available from Evonik and Byk-535 available from Byk.

A defoamer (or called an anti-foaming agent) is a chemical additive that can reduce and hinder the formation of foam in industrial process liquids. Defoamers can prevent the formation of foam during manufacture of the ink. Examples of defoamers include TEGO Foamex from Evonik, Byk-1790, and BYK-1791 from BYK.

Embodiments of the ink composition may contain de-aerators (e.g., BYK-535) or defoamer (e.g., BYK-1791) in a loading of about 0% to about 2% based on the weight of the total ink composition, such as about 0.1% to about 2%, about 0.5% to about 1.5%, about 0.1% to about 1%, or about 0.25% to about 0.5% based on the weight of the total ink composition. In some embodiments, the ink composition includes the de-aerator or defoamer at greater than 0%, greater than 0.1%, or greater than 0.5% based on the weight of the total ink composition. In some embodiments, the ink composition includes the de-aerator or defoamer at less than 2%, less than 1.5%, or less than 1% based on the weight of the total ink composition.

### Properties of the Ink Compositions

The ink composition can have a surface tension that allows it to be applicable as an energy curable inkjet ink. The surface tension of the ink composition can be about 20 mN/m to about 27 mN/m at room temperature, such as about 21 mN/m to about 26 mN/m, about 22 mN/m to about 25 mN/m, about 20 mN/m to about 25 mN/m, or about 23 mN/m to about 27 mN/m at room temperature. In some embodiments, the ink composition has a surface tension of greater than 20 mN/m, greater than 21 mN/m, greater than 22 mN/m, or greater than 23 mN/m at room temperature. In some embodiments, the ink composition has a surface tension of less than 27 mN/m, less than 26 mN/m, less than 25 mN/m, or less than 24 mN/m at room temperature. Surface tension of the ink composition can be measured by techniques used within the art, such as by a force tensiometer.

The ink composition can also have a viscosity that allows it to be applicable as an energy curable inkjet ink. The ink composition can have a viscosity of about 10 cPs to about 40 cPs at about 25° C., such as about 12 cPs to about 35 cPs, about 12 cPs to about 30 cPs, about 10 cPs to about 25 cPS, about 10 cPs to about 20 cPs, about 20 cPs to about 40 cPs, about 15 cPs to about 35 cPs, or about 15 cPs to about 28 cPs at about 25° C. In some embodiments, the ink composition has a viscosity of greater than 10 cPS, greater than 15 cPs, or greater than 20 cPs at about 25° C. In some embodiments, the ink composition has a viscosity of less than 40 cPs, less than 35 cPs, or less than 30 cPS at about 25° C. Viscosity of the ink composition can be measured by techniques used within the art, such as by viscometers (e.g., capillary viscometer, vibrating viscometer, etc.) and rheometers (e.g., rotational, microfluidic, etc.).

The ink composition can also have a low odor profile. The odor profile can be measured by an olfactory analysis as discussed in the Examples below.

In some embodiments, the ink composition has one of the following: a viscosity of no more than 40 cPs at about 25° C.; a surface tension of no less than 20 mN/m at room temperature; a low odor profile as measured by an olfactory analysis; or a combination thereof.

The inkjet ink composition can have a desired good lay and pin-hole-free properties.

### Example Ink Composition Embodiments

In some embodiments, the ink composition includes, in percent by weight based on the weight of the total ink composition: about 10% to about 35% of a hydrophilic mono-functional monomer; about 30% to about 70% of a di-functional monomer; about 0% to about 4% of a colorant; and an optional photoinitiator.

In some embodiments, the ink composition includes, in percent by weight based on the weight of the total ink composition: about 5% to about 35% of a hydrophilic mono-functional monomer; about 0% to about 15% of a hydrophobic mono-functional monomer; about 30% to about 65% of a di-functional monomer; about 0% to about 4% of a colorant; and about 0% to about 15% of a photoinitiator.

In some embodiments, the ink composition includes, in percent by weight based on the weight of the total ink composition: about 10% to about 35% of a hydrophilic mono-functional monomer; about 3% to about 12% of a hydrophobic mono-functional monomer; about 30% to about 60% of a di-functional monomer; about 1% to about 4% of a colorant; and about 0% to about 12% of a photoinitiator

In some embodiments, the ink composition includes, in percent by weight based on the weight of the total ink composition: about 5% to about 35% of a hydrophilic mono-functional monomer; about 0% to about 15% of a hydrophobic mono-functional monomer; about 30% to about 70% of a di-functional monomer; about 0% to about 4% of a colorant; about 0% to about 15% of a photoinitiator; and a functional material selected from the group consisting of an inert resin, an oligomer, a synergist, a stabilizer, a wetting/flow agent, a de-foamers, and a combination thereof.

### Substrate

Also provided herein are substrates that have the cured ink composition positioned on a surface of the substrate, which can be referred to as a decorated substrate. For example, the decorated substrate can include a substrate and a cured ink composition derived from a disclosed ink composition on a surface of the substrate.

The substrate may be a container, such as a container used in the food or beverage industry. In some embodiments, the substrate is a beverage container. The substrate may be metal, paper, plastic, or a combination thereof. In some embodiments, the substrate is metal, paper, or plastic. The substrate may be a metal container (e.g., metal can), paper container (e.g., paper-based carton), or a plastic container (e.g., plastic bottle). In some embodiments, the substrate is a metal container. In some embodiments, the substrate is a metal container for beverage or food.

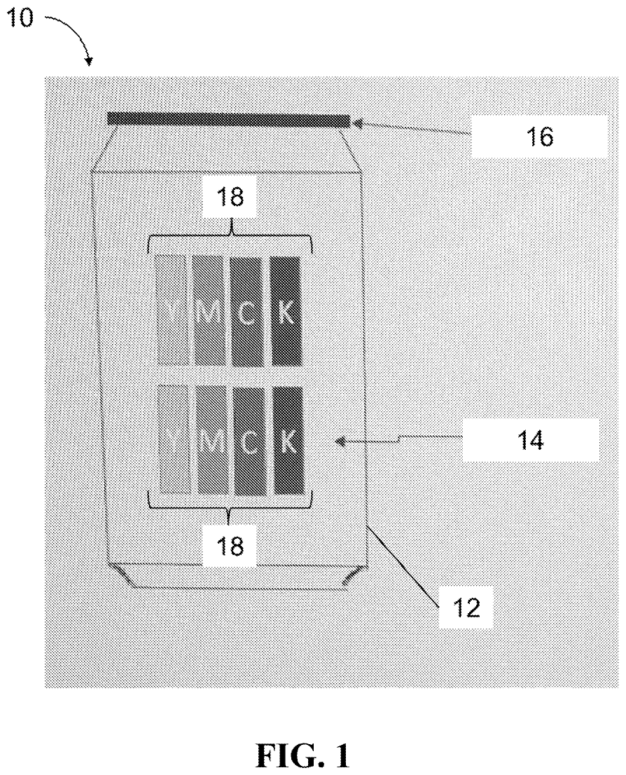

An example substrate 10 is shown in FIG. 1. The substrate 10 includes a two-piece can body 12 with a first portion 14 and a second portion 16. The first portion 14 defines a bottom end and the body 12 and is shaped from one sheet of metal by deep drawing. The second portion 16 defines a second end seamed to the body first portion 14 to close it and form a complete body 12. Inks 18 are deposited on the substrate 10 through a four-color process printing. In the illustrated embodiment ink 18 colors are referenced as YMCK, which denote the colors yellow, magenta, cyan, and black.

A surface of the substrate 10 may include the substrate itself, a precoating positioned on a surface of the substrate, or a combination thereof. Accordingly, in some embodiments, the cured ink composition is positioned on a surface of a precoating, the precoating positioned on a surface of the substrate. In other words, the precoating can be positioned between the surface of the substrate and the cured ink composition. In some embodiments, the precoating is a white base coat.

The substrate can further include a coating positioned on a surface of the cured ink composition. For example, the substrate can include a coating that is visually clear positioned on a surface of the cured ink composition.

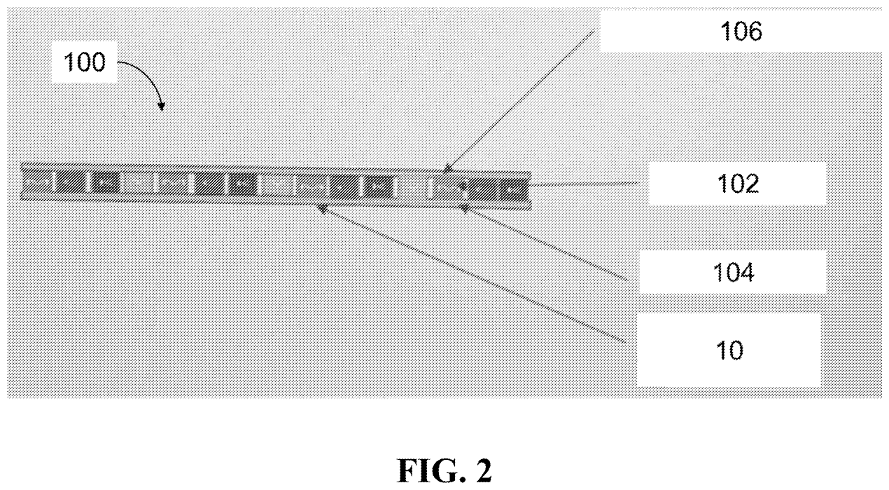

An example coated substrate 100 is shown in FIG. 2, which is an illustration of a cross-section of a finished substrate 100 printed with the disclosed ink compositions 102 through jetting. During the coating process, a substrate (e.g., substrate 10 above) is precoated with a base coat 104 by depositing the base coat 104 on a surface of the substrate 10. The ink composition 102 is jetted on a surface of the base coat 104 (i.e., the precoated substrate 10) and then cured. Finally, a water-base overprint varnish 106 is imprinted on top of the cured ink composition 102.

The precoating or base coat may have a coat weight of about 2.5 gsm to about 10.5 gsm, such as about 2.5 gsm to about 10.3 gsm, about 3 gsm to about 10.3 gsm, about 3 gsm to about 9.3 gsm, about 3.5 gsm to about 8.3 gsm, about 4 gsm to about 7.3 gsm, about 3.5 gsm to about 6.3 gsm, about 3 gsm to about 5.3 gsm, about 6.2 gsm to about 10.3 gsm, or about 2.5 gsm to about 4 gsm. In some embodiments, the precoating has a coat weight of greater than 2.5 gsm, greater than 3 gsm, greater than 3.5 gsm, greater than 4 gsm, greater than 5 gsm, greater than 6 gsm, or greater than 7 gsm. In some embodiments, the precoating has a coating weight of less than 10.5 gsm, less than 10.3 gsm, less than 9 gsm, less than 8 gsm, less than 7 gsm, less than 6 gsm, less than 5 gsm, less than 4.5 gsm, or less than 4 gsm.

The cured ink composition deposited on a surface of the substrate or on a precoated surface may have a coat weight of about 0.5 gsm to about 15 gsm, such as about 0.5 gsm, to about 10 gsm, about 1 gsm to about 10 gsm, about 2 gsm to about 8 gsm, about 1.5 gsm to about 9.5 gsm, about 0.5 gsm to about 5 gsm, about 1 gsm to about 6 gsm, about 6.5 gsm to about 10 gsm, about 7 gsm to about 9.5 gsm, about 8 gsm to about 10 gsm, or about 6 gsm to about 8 gsm. In some embodiments, the cured ink composition has a coat weight of greater than 0.5 gsm, greater than 1 gsm, greater than 2 gsm, greater than 3 gsm, greater than 4 gsm, greater than 5 gsm, greater than 6 gsm, greater than 6.5 gsm, or greater than 7 gsm. In some embodiments, the cured ink composition has a coat weight of less than 15 gsm, less than 12 gsm, less than 10 gsm, less than 9.5 gsm, less than 8 gsm, less than 7 gsm, less than 6 gsm, or less than 5 gsm.

The coating positioned on a surface of the cured ink composition may have a coat weight of about 1.5 gsm to about 5 gsm, such as about 2 gsm to about 4.5 gsm, about 2.5 gsm to about 4 gsm, about 3 gsm to about 4.5 gsm, about 1.5 gsm to about 3 gsm, about 1.5 gm to about 2.5 gsm, or about 1.5 gsm to about 4.1 gsm. In some embodiments, the coating has a coat weight of greater than 1.5 gsm, greater than 2 gsm, 2.5 gsm, greater than 3 gsm, or greater than 3.5 gsm. In some embodiments, the coating has a coating weight of less than 5 gsm, less than 4.5 gsm, less than 4 gsm, less than 3 gsm, or less than 2.5 gsm.

The decorated substrate can also have an advantageous low level of contamination that can arise from curing of the ink composition. For example, the decorated substrate can have a level of contamination from uncured monomer, photoinitiator, or a combination thereof of less than 50 parts per billion (ppb) as measured by an alcohol extraction test, such as less than 45 ppb, less than 40 ppb, less than 35 ppb, less than 30 ppb, less than 25 ppb, less than 20 ppb, less than 15 ppb, or less than 10 ppb as measured by an alcohol extraction test. An example alcohol extraction test is described in the Examples.

### Methods

Also provided herein are methods of applying the ink composition to a surface of a substrate to, e.g., provide a decorated substrate. The description of the different monomers, colorants, functional materials, and substrate can also be applied to the methods disclosed herein.

The method can include applying an ink composition as disclosed herein to a surface of a substrate, which can be metal, paper, plastic, or a combination thereof. In some embodiments, the method includes jetting the ink composition on a surface of the substrate. In some embodiments, the ink composition is printed with a Mayer rod. In some embodiments, the substrate is metal such as a metal can. In some embodiments, the metal can is precoated. For example, the ink composition can be jetted onto a white base can or on a clear coated can.

The method can further include irradiating the ink composition to cure the ink composition on the surface of the substrate to provide a decorated substrate. The method can include LED curing, UV Curing, or EB curing the ink composition on the substrate surface. This can provide a cured ink composition on the substrate surface. The cured ink composition can be tack-free.

In some embodiments, the substrate is coated with a white base coat prior to contacting with the ink composition.

The method can also include laminating the cured ink composition by imprinting a water-based overprint varnish through a roll coat process to provide an imprinted substrate (e.g., imprinted metal can).

In some embodiments, the ink composition is printed with a Mayer rod.

Further, the method can include the decorated substrate, which can be imprinted, being baked at high temperatures. For example, the decorated substrate may be baked at about 350° F. to about 400° F. Baking can be done for about 10 seconds to about 10 minutes, such as about 30 seconds to about 5 minutes or about 1 minute to about 7 minutes. The baking can impart useful properties to the substrate such as, low odor, low extraction, chemical resistance, and pasteurization resistance. This is useful in industries such as metal beverage/food container industries.

### EXAMPLES

The following examples, including experiments and results achieved, are provided for illustrative purposes only and are not to be construed as limiting the claimed subject matter. All amounts listed in the following examples are in weight percentage (wt %) unless specified otherwise.

### Example 1: YMCK Pigment Dispersions

### Preparation of YMCK Pigment Dispersions

The pigment dispersions were prepared using 0.3 mm zirconium oxide beads as the milling media. Suitable amounts of dispersants, monomer, stabilizer and pigments were added to a 2000 ml metal container. The ratios of the above components are given in Table 1-1. Each of the mixtures in Table-1-1 were homogenized at 3000 rpm for 30 minutes using a homogenizer. The corresponding suspension was transferred to a HCPN mill containing the zirconium oxide 0.3 mm beads and the mill was run at 4000 rpm for 4-20 hours to get the corresponding YMCK pigment dispersions.

TABLE 1-1
YMCK pigment dispersions prepared with 0.3 mm zirconium oxide beads

| | Example-1-1 | Example-1-2 | Example-1-3 | Example-1-4 |
|---|---|---|---|---|
| | Dispersion-1 | Dispersion-2 | Dispersion-3 | Dispersion-4 |
| | (YELLOW) | (MAGENTA) | (CYAN) | (BLACK) |
| | % | % | % | % |
| Dispersant -1 | 10.00 | | | 15.00 |
| Dispersant - 2 | | 15.00 | 7.50 | |
| Di-functional monomer | 65.00 | 57.00 | 62.50 | 55.00 |
| Inhibitor - 1 | 5.00 | 5.00 | 5.00 | 5.00 |
| Blue Pigment | | | 25.00 | |
| Magenta Pigment | | 23.00 | | |
| Yellow Pigment | 20.00 | | | |
| Black Pigment | | | | 25.00 |
| Total | 100.00 | 100.00 | 100.00 | 100.00 |

### Properties of YMCK Pigment Dispersions

The viscosity of the pigment dispersion was measured using a Brookfield CAP 2000 plus unit at 25° C., by which the #1 spindle was operated at the shear rate of 225 rpm and held for 60 seconds.

The particle size analyzer used for the pigment dispersion was a Malvern Zeta Sizer Nano series, Zen 3600 unit (Goffin-Meyvis). The determination of the numeric average particle diameter is performed by photon correlation spectroscopy at a wavelength of 633 nm with a 4 mW He—Ne laser on a diluted sample of the pigment dispersion. The measured particle size is the average value of 3 consecutive measurements consisting of 12 runs of 20 seconds.

The pigment dispersion (30 g) was filled and sealed in a 60 ml black jar. The odor was assessed within 10 seconds after the lid used to seal the jar was open. A score of A to E was assigned to each of the pigment dispersions, where “E” denotes strong, unpleasant odor and “A” denotes insignificant odor emanating from the pigment dispersion. A scale of A or B, (more preferably scale of A), is desirable for pigment dispersion to be used for the preparation of the metal decoration inkjet ink.

As shown in Table 1-2, the resulting pigment dispersions exhibited an average particle size of 99.7 nm and a viscosity of 169.2 cPs for dispersion-1 (yellow dispersion in example-1-1), an average particle size of 106.4 nm and a viscosity of 199.2 cPs for dispersion-2 (magenta dispersion in example-1-2), an average particle size of 140.4 nm and a viscosity of 75.8 cPs for dispersion-3 (cyan dispersion in example-1-3), and an average particle size of 156.1 nm and a viscosity of 277.5 cPs for dispersion-4 (black dispersion in example-1-4). All the YMCK pigment dispersions prepared from Example-1 gave a scale of A in the odor evaluation.

The resulting pigment dispersions are also able to give a scale of A in the odor evaluation while they possess different viscosity values and particle size values. The pigment dispersions were prepared with other low odor di-functional monomers.

Monomers, such as isobornyl acylate (IBOA), 2-phenoxyethyl acrylate (2PEA), and 1,6-hexanediol diacrylate (HDDA), were not selected to prepare the YMCK pigment dispersions, due to their unpleasant odors, health hazard rating, and/or toxicity potential.

TABLE 1-2
properties of the pigment dispersions

| | Example-1-1 | Example-1-2 | Example-1-3 | Example-1-4 |
|---|---|---|---|---|
| | Dispersion-1 | Dispersion-2 | Dispersion-3 | Dispersion-4 |
| | YELLOW | MAGENTA | CYAN | BLACK |
| Dispersion viscosity (cPs at | 169.2 | 199.2 | 75.8 | 277.5 |
| 25° C.) | | | | |
| Average particle size (nm) | 99.7 | 106.4 | 140.4 | 156.1 |
| Odor evaluation (Scale) | A | A | A | A |

### Example 2: Black Ink Compositions Comprising Hydrophilic Mono-Functional Monomers and/or Hydrophobic Mono-Functional Monomers

### Ink Preparation

The black inks (Example-2-1 through Example-2-6) were prepared by mixing the components listed in Table-2-1 using a Caframo constant-torque brushless mixer. Each of the blends were agitated at 500 rpm to 1500 rpm under 60° C. for 35 minutes until a homogeneous ink solution was formed. The homogeneous inks were filtered with a 1 micro filter (provided by Pall Canada) to remove any impurities and then kept in a black jar, respectively.

All the inks listed were prepared using the identical black pigment dispersion (i.e., dispersion-4 prepared from Example-1 above), the identical photoinitiators, the identical inhibitors, the identical flow agent, and the identical di-functional monomer. The main differences existed in the mono-functional monomers used.

In Example-2-1, the ink composition contains 26% of low odor hydrophilic monomer-2 and 3.5% of low odor hydrophobic monomer-1.

In Example-2-2, the ink composition contains 16% of low odor hydrophilic monomer-1.

In Example-2-3, the ink composition contains 16% of low odor hydrophobic monomer-1.

In Example-2-4, the ink composition contains 16% of high odor hydrophobic monomer-2.

In Example-2-5, the ink composition contains 16% of high odor hydrophobic monomer-3.

In Example-2-6, the ink composition contains 16% of low odor hydrophobic monomer-4.

TABLE 2-1
black inks comprising hydrophilic and/or hydrophobic
mono-functional monomers

| | Ex- | Ex- | Ex- | Ex- | Ex- | Ex- |
|---|---|---|---|---|---|---|
| | ample- | ample- | ample- | ample- | ample- | ample- |
| | 2-1 | 2-2 | 2-3 | 2-4 | 2-5 | 2-6 |
| Hydrophobic | 3.50 | | 16.00 | | | |
| mono-functional | | | | | | |
| monomer-1 | | | | | | |
| Hydrophilic | | 16.00 | | | | |
| mono-functional | | | | | | |
| monomer-1 | | | | | | |
| Hydrophilic | 26.00 | | | | | |
| mono-functional | | | | | | |
| monomer-2 | | | | | | |
| Hydrophobic | | | | 16.00 | | |
| mono-functional | | | | | | |
| monomer-2 | | | | | | |
| Hydrophobic | | | | | 16.00 | |
| mono-functional | | | | | | |
| monomer-3 | | | | | | |
| Hydrophobic | | | | | | 16.00 |
| mono-functional | | | | | | |
| monomer-4 | | | | | | |
| Photoinitiator-1 | 4.50 | 4.50 | 4.50 | 4.50 | 4.50 | 4.50 |
| Photoinitiator-2 | 3.50 | 3.50 | 3.50 | 3.50 | 3.50 | 3.50 |
| Photoinitiator-3 | 1.65 | 1.65 | 1.65 | 1.65 | 1.65 | 1.65 |
| Di-functional | 48.60 | 62.10 | 62.10 | 62.10 | 62.10 | 62.10 |
| monomer | | | | | | |
| Inhibitor-2 | 1.00 | 1.00 | 1.00 | 1.00 | 1.00 | 1.00 |
| Inhibitor-3 | 0.40 | 0.40 | 0.40 | 0.40 | 0.40 | 0.40 |
| Flow agent | 0.10 | 0.10 | 0.10 | 0.10 | 0.10 | 0.10 |
| Dispersion-4 | 10.75 | 10.75 | 10.75 | 10.75 | 10.75 | 10.75 |
| (black) | | | | | | |
| Total | 100 | 100 | 100 | 100 | 100 | 100 |

### Ink Properties

The viscosity of the above inks was measured using a Brookfield viscometer DV2 unit, with water jacket at 25° C. and 45° C., respectively. The “00” type spindle is operated at the shear rate from 10 rpm (25° C.) to 30 rpm (45° C.). To be suitable for ink jetting, disclosed ink compositions have a viscosity of less than 15 cPs at 45° C., such as less than 12 cPs at 45° C.

The static surface tension of the above inks was measured with a KRÜSS tensiometer K-11 unit from KRÜSS GmbH, Germany at 25° C. The surface tension, in the range of about 20 to about 27 mN/m, is desirable for the inkjet ink to apply to the metal can decoration.

The ink (30 g) was filled and sealed in a 60 ml black jar. The odor of the wet ink was assessed within 10 seconds after the lid used to seal the jar was open. A score of A to E was assigned to each ink, where “E” denotes strong, unpleasant odor and “A” denotes insignificant odor emanating from the ink. A scale of A or B, (more preferably scale of A), is desirable for the inkjet ink to be applied to the metal can decoration.

TABLE 2-2
Properties of black inks containing hydrophilic and hydrophobic
mono-functional monomers

| | Ex- | Ex- | Ex- | Ex- | Ex- | Ex- |
|---|---|---|---|---|---|---|
| | ample- | ample- | ample- | ample- | ample- | ample- |
| | 2-1 | 2-2 | 2-3 | 2-4 | 2-5 | 2-6 |
| Mono- | Philic-2/ | Philic- | Phobic- | Phobic- | Phobic- | Phobic- |
| functional | Phobic-1 | 1 | 1 | 2 | 3 | 4 |
| monomers | | | | | | |
| used | | | | | | |
| Viscosity at | 25.8 | 13.7 | 11.3 | 13.3 | 14.4 | 19.0 |
| digital lab | | | | | | |
| at 25° C. | | | | | | |
| Viscosity at | 11.2 | 7.04 | 6.26 | 6.90 | 7.20 | 9.30 |
| digital lab | | | | | | |
| at 45° C. | | | | | | |
| Surface | 25.84 | 25.64 | 25.73 | 25.55 | 25.49 | 25.68 |
| tension | | | | | | |
| (mN/m) | | | | | | |
| Odor scale | A | A | A | E | D | A |
| of wet ink | | | | | | |

All the inks above present desirable viscosity values and surface tension values for inkjet application. However, for the wet inks, only those prepared with low odor monomers (that is Example-2-1, Example-2-2, Example-2-3, and Example-2-6) can deliver the desirable low odor properties (scale A) in the odor evaluation.

### Ink Performance

The above inks were printed, with a #6 Mayer Rod, onto a flat white base metal sheet (obtained by cutting a 12 oz white base can and having it flatten). The white base can was prepared by roll-coating a layer of water-based coat on the can surface and having it baked at 340-390° F. for around 45 seconds. The white base can was available from Ball Corporation, USA, or other can manufacturers. The printed inks were LED cured through an AMS LED curing unit (provided by Air Motion System) equipped with a 17 w/cm LED lamp at the dose of 400 mj/cm2 of total UV-A2. The prints were then evaluated immediately (within 10 seconds after curing) for surface odor-ness. The latitude of the odor is different from wet ink evaluation and pigment dispersion evaluation, thus a score of 1 to 5 was assigned to each print, where 5 denotes relatively strong, unpleasant odor and 1 denotes relatively insignificant odor emanating from the print. In general, the score of 1 is desirable for the energy cured cans.

Next, a water-based overprint varnish (PPG3825803, commercially available from PPG) was applied, through a #6 Mayer Rod, onto the LED cured ink layer of the above metal can sheet. The can sheet was then allowed to be oven baked at 360° F. to 400° F. for 3 minutes. After that, the finished print was evaluated in terms of its odor-ness, print density, gloss level, MEK rub resistance, pencil hardness, crosshatch adhesion, and pasteurization resistance. The corresponding results were given in Table-2-3.

It should be mentioned that the odor evaluation for the finished metal can (ink/OPV) was conducted within 10 seconds after the baked can was removed from the oven and cooled down for 1 minute. The evaluation method is the same as it was used for the cured ink, as described above in the ink performance section (ink only). A score of L-1 to L-5 was assigned to each can, where L-5 denotes relatively strong, unpleasant odor and L-1 denotes relatively insignificant odor emanating from the can. In general, the score of L-1 is desirable for the beverage can application.

The print density of the printed can was measured using a module RN 42 densitometer attached in the X-rite unit from Grand Rapids, Mich., USA. A print density of 1.0 (or higher) for yellow, 1.5 (or higher) for magenta, 1.5 (or higher) for cyan, and 1.5 (or higher) for black is generally desirable for the beverage can decoration.

The gloss level of the printed can was measured according to ASTM D523-08. A reading of 80 (or above) at 60 degree angle is generally desirable for beverage can application.

In the beverage can industry, MEK rub test is used to simulate what the can would encounter in plant, filling, or environment. During the test, the can sample is cut down and flattened, taped to tray. The MEK rub guide was placed to can in testing area to isolating the longest stroke area of can. A 30 double rubs, and preferably 50 double rubs (or higher) are desirable for the cans to be used in beverage industry.

The pencil scale is a test of hardness that gives an impression on how hard a certain coating is. The test is done, according to ASTM D 3363, by pressing a pencil with a certain hardness firmly on the surface on a 45 degrees angle. The highest grade that does not permanently mark the surface is the score for the pencil scale. In the beverage can industry, the coatings in their final cured stage (finished can with cured ink and cured overprint varnish) may have a pencil hardness between 3B to 9H.

The crosshatch tape adhesion was evaluated according to ASTM D3359-09 Standard Test Method for Measuring Adhesion by Tape Test. This included using a crosshatch tool to scratch a grid into the surface of the can body. A piece of adhesive tape (such as the premium grade transparent cellophane Scotch 610-1PK from 3M) was then placed over the grid and pressed firmly into place. The tape was then removed at a medium pressure at 180 degrees. The percentage of ink/coat/paint pulled off with the adhesive in relation to the grid was examined. Upon the percentage area removed by the tape, the adhesion is classified as 6 grades (5B, 4B, 3B, 2B, 1B, 0B). Of them, 5B represents the best adhesion property—where the edges of the cuts are completely smooth and none of the squares of the lattice is detached (this is so-called 0% of removal of coat/ink/paint), and 4B represents outstanding adhesion property—where the detachment of small flakes is observed at the intersections of the cuts, but generally less than 5% of cross-cut area is affected. In the beverage can industry, it is desirable for the decorated cans, and the pasteurized cans to have a 4B grade or 5B grade in the crosshatch tape test.

The pasteurization test involves the evaluation of cross hatch tape adhesion, blushing evaluation, and color fading evaluation to the beverage can after it has been soaked in 0.7% surfactant solution (such as Joy solution) at 80° C. for 30 minutes. When the cross-hatch-tape adhesion is conducted per ASTM D3359-09, the tape is also placed under microscope to see if interior squares of cross hatch are visible and if the disruptions in overprint varnish and adhesion loss occurred. The blushing evaluation is used to see if any water has been absorbed into the coating, which would result in white-ish discoloration on the print surface. The color fading evaluation is used to see if any water has been absorbed through the coating, which would result in ink color fading. Both blushing evaluation and color fading evaluation were conducted visually.

TABLE 2-3
Performance of black inks comprising hydrophilic
and/or hydrophobic mono-functional monomers

| | Ex- | Ex- | Ex- | Ex- | Ex- | Ex- |
|---|---|---|---|---|---|---|
| | ample- | ample- | ample- | ample- | ample- | ample- |
| | 2-1 | 2-2 | 2-3 | 2-4 | 2-5 | 2-6 |
| Mono- | Philic- | Philic- | Phobic- | Phobic- | Phobic- | Phobic- |
| functional | 2 + | 1 | 1 | 2 | 3 | 4 |
| monomers | Phobic- | | | | | |
| used | 1 | | | | | |
| Odor scale of | 1 | 1 | 1 | 4 | 3 | 1 |
| cured ink | | | | | | |
| (ink only) | | | | | | |
| Odor scale of | L-1 | L-1 | L-1 | L-2 | L-2 | L-1 |
| finished can- | | | | | | |
| (ink/OPV) | | | | | | |
| Print density | 2.00 | 1.96 | 1.92 | 1.96 | 1.97 | 1.96 |
| of finished | | | | | | |
| can (ink/ | | | | | | |
| OPV) | | | | | | |
| Gloss of | 87.9 | 85.4 | 92.2 | 89.9 | 80.8 | 90.6 |
| finished can | | | | | | |
| (ink/OPV) | | | | | | |
| Cross hatch | 4B-5B | 4B-5B | 0B | 0B | 3B | 2B |
| adhesion of | | | | | | |
| finished can | | | | | | |
| (ink/OPV) | | | | | | |
| MEK | 50 plus | 50 plus | 50 plus | 50 plus | 50 plus | 50 plus |
| resistance of | | | | | | |
| finished can | | | | | | |
| (ink/OPV) | | | | | | |
| Pencil | 2H | 2H | 2H | 2H | 2H | 2H |
| hardness of | | | | | | |
| finished can | | | | | | |
| (ink/OPV) | | | | | | |
| Pasteurization | 4B-5B | 4B-5B | 0B | 0B | 3B | 2B |
| of finished | | | | | | |
| can (ink/ | | | | | | |
| OPV)-by | | | | | | |
| cross hatch | | | | | | |
| 810 tape | | | | | | |
| evaluation | | | | | | |
| Pasteurization | Pass | Pass | Pass | Pass | Pass | Pass |
| of finished | | | | | | |
| can (ink/ | | | | | | |
| OPV)-by | | | | | | |
| blushing | | | | | | |
| evaluation | | | | | | |
| Pasteurization | Pass | Pass | Pass | Pass | Pass | Pass |
| of finished | | | | | | |
| can (ink/ | | | | | | |
| OPV)-by | | | | | | |
| color fading | | | | | | |
| evaluation | | | | | | |

It can be seen from Table-2-3 that the cured inks followed the same pattern as the wet inks, in terms of the odor properties. The low odor inks (i.e., the inks from Example-2-1, Example-2-2, Example-2-3, and Example-2-6) generated lower odor once they were LED cured, with an odor scale of 1. When a water-based over print varnish (OPV) was applied to the corresponding low odor ink layer, the odor from the finished can was also low, staying in L-1 range. When a water-based over print varnish was applied to the corresponding high odor inks (the inks in Example-2-4 and Example-2-5), the odor from the finished can was reduced but the corresponding odor scales were still in L-2 range.

All the cans decorated with the above inks presented desirable print density, gloss level, pencil hardness, and MEK rub resistance. However, the cans decorated with the inks from Example-2-3, Example-2-4, Example-2-5, and Example-2-6 failed the crosshatch tape adhesion test, with the corresponding scale of 0B, 0B, 3B, and 2B for both the finished cans and the pasteurized cans, respectively. Only the inks containing the hydrophilic components in their polymerizable compositions (for instance, Example-2-1 and Example-2-2) were able to provide the decorated cans (both the finished cans and the pasteurized cans) with the desired adhesion properties (i.e., pass the crosshatch tape adhesion test).

### Example 3: Black Ink Compositions Having Different Average Functionality of Polymerizable Components (or Different Average Double-Bond Density of Polymerizable Components)

### Ink Preparation

The black inks (Example-3-1 through to Example-3-6) were prepared by mixing the components listed in Table-3-1 using a Caframo constant-torque brushless mixer. Each of the blends were agitated at 500 rpm to 1500 rpm under 60° C. for 35 minutes until a homogeneous ink solution is formed. The homogeneous inks were filtered with a 1 micro filter (provided by Pall Canada) to remove any impurities and then kept in a black bottle, respectively.

All the inks were prepared using the identical black pigment dispersion (i.e., dispersion-4 prepared from Example-1 above), the identical photoinitiators, the identical inhibitors, the identical flow agent, the identical hydrophilic monomer, the identical hydrophobic monomer, and the identical multi-functional monomer. The main differences existed in the ratio of the di-functional monomer to the mono-functional monomer.

In Example-3-1: the ink composition has a high loading (52.10%) of di-functional monomer. Taking the di-functional monomer content (coming from the pigment dispersion) into consideration, the total loading of the di-functional monomer in the ink composition is 58.01% (that is 52.10%+5.91%=58.01%), so the ratio of the di-functional monomer to the mono-functional monomer in the ink composition is 2.23.

Based on the same principle, the ratio of the di-functional monomer to the mono-functional monomer in the ink compositions for Example-3-2, Example-3-3, Example-3-4, Example-3-5, and Example-3-6 are 1.44, 0.86, 0.50, 0.26, and 0.08, respectively.

Since tri-functional monomers and other higher functionality monomers may also be applied to the ink composition, the concept of “average functionality of polymerizable components” or “average double bond density of polymerizable components” was introduced herein for an easier understanding of the extent of polymerization of the ink compositions. The average double bond density of polymerizable components can be calculated through the equation below.

Average double bond density (or average functionality) of polymerizable components=(1×mole number of monofunctional component+2×mole number of di-functional component+3×mole number of tri-functional component+ . . . )/total mole number of polymerizable components (or total mole number of un-saturated components). For instance, the average double bond density (or average functionality) of polymerizable components for the ink in Example-3-1 will be calculated as follows:
(1×mole number of monofunctional monomer+2×mole number of di-functional monomer) divided by the total mole number of monofunctional monomer and di-functional monomer.

The corresponding average double bond density (average functionality) of polymerizable components for inks in Example-3-1, Example-3-2, Example-3-3, Example-3-4, Example-3-5, and Example-3-6 are 1.69, 1.59, 1.45, 1.32, 1.20, and 1.07, respectively.

TABLE 3-1
black ink composition containing monomers with
different average double bond density

| | Ex- | Ex- | Ex- | Ex- | Ex- | Ex- |
|---|---|---|---|---|---|---|
| | ample- | ample- | ample- | ample- | ample- | ample- |
| | 3-1 | 3-2 | 3-3 | 3-4 | 3-5 | 3-6 |
| Hydrophilic | 26.00 | 26.00 | 26.00 | 26.00 | 26.00 | 26.00 |
| mono-functional | | | | | | |
| monomer-2 | | | | | | |
| Hydrophobic | | 8.50 | 19.25 | 30.00 | 40.75 | 52.10 |
| mono-functional | | | | | | |
| monomer-2 | | | | | | |
| Photoinitiator-1 | 4.50 | 4.50 | 4.50 | 4.50 | 4.50 | 4.50 |
| Photoinitiator-2 | 3.50 | 3.50 | 3.50 | 3.50 | 3.50 | 3.50 |
| Photoinitiator-3 | 1.65 | 1.65 | 1.65 | 1.65 | 1.65 | 1.65 |
| Di-functional | 52.10 | 43.60 | 32.85 | 22.10 | 11.35 | |
| monomer | | | | | | |
| Inhibitor-2 | 1.00 | 1.00 | 1.00 | 1.00 | 1.00 | 1.00 |
| Inhibitor-3 | 0.40 | 0.40 | 0.40 | 0.40 | 0.40 | 0.40 |
| Flow agent | 0.10 | 0.10 | 0.10 | 0.10 | 0.10 | 0.10 |
| Dispersion-4 | 10.75 | 10.75 | 10.75 | 10.75 | 10.75 | 10.75 |
| (Black) | | | | | | |
| Total | 100.00 | 100.00 | 100.00 | 100.00 | 100.00 | 100.00 |
| Ratio of di- | 2.23 | 1.44 | 0.86 | 0.50 | 0.26 | 0.08 |
| functional | | | | | | |
| monomer(s) to | | | | | | |
| mono-functional | | | | | | |
| monomer(s) | | | | | | |
| Average double | 1.69 | 1.59 | 1.45 | 1.32 | 1.20 | 1.07 |
| bond density of | | | | | | |
| polymerizable | | | | | | |
| components | | | | | | |

### Ink Properties

The viscosity, static surface tension, and the odor of the inks in Example-3 were tested and evaluated using the same methods described in Example-2. The results are summarized in Table-3-2.

TABLE 3-2
Ink properties of black ink compositions having different
average double bond density

| | Ex- | Ex- | Ex- | Ex- | Ex- | Ex- |
|---|---|---|---|---|---|---|
| | ample- | ample- | ample- | ample- | ample- | ample- |
| | 3-1 | 3-2 | 3-3 | 3-4 | 3-5 | 3-6 |
| Viscosity at | 24.4 | 18.6 | 20.0 | 21.2 | 23.4 | 27.0 |
| 25° C. (cPs) | | | | | | |
| Viscosity at | 11.06 | 9.42 | 9.76 | 10.34 | 11.18 | 12.58 |
| 45° C. (cPs) | | | | | | |
| Surface tension | 25.41 | 25.34 | 25.61 | 25.37 | 25.66 | 25.44 |
| (mN/m) | | | | | | |
| Odor scale of | A | B | C | D | E | E |
| wet ink | | | | | | |

All the inks present desirable viscosity values and surface tension values for inkjet application. However, for the wet inks, only the ink prepared in Example-3-1 can deliver the desirable low odor properties (scale A) in the odor evaluation. With the increased use of high-odor (also high evaporation rate) monomer in Example-3-2 through to Example-3-6, the odor issues become more serious, with a corresponding odor scale of B, C, D, E, E, respectively.

### Ink Performance

The performance of the inks prepared in Example 3 was evaluated using the same methods described in Example 2 above.

It can be seen from Table-3-3 that the cured inks follow similar patterns as the wet inks, in terms of the odor properties. The low odor ink (i.e., Example-3-1) generated lower odor once it was LED cured, with the odor scale of 1. When a water-based over print varnish was applied to the corresponding low odor ink layer, the odor from the finished can stayed in L-1 range. When a water-based over print varnish was applied to the corresponding high-odor ink layers (Example-3-2 through to Example-3-6), the odor from the finished cans had an odor scale of L-2 to L-3.

The cans decorated with the above inks presented desirable print density and gloss level. The ink compositions having a higher average double bond density (1.69, 1.59, and 1.46 in Example-3-1, Example-3-2, and Example-3-3) were able to provide desirable pencil hardness and MEK rub resistance. Of them, Example-3-1, which has much higher average double bond density (i.e., 1.69) in its composition, was able to provide improved crosshatch adhesion property (4B-5B) and the corresponding finished can was able to withstand the pasteurization treatment. This finding is surprising as it is contrary to the conventional wisdom by which people were taught the desired adhesion property can only be obtained from the low crosslinked ink film. The conventional wisdom further believed that the ink, based on mono-functional monomers, would lose its broad spectrum adhesion if it was incorporated with a di-functional monomer at a level greater than 10% (in this case, by calculation the corresponding average double bond density of polymerizable components would be around 1.10), or if it was incorporated a tri-functional monomer at a level greater than 5% (in the case, by calculation the corresponding average double bond density of polymerizable components would also be around 1.10). According to this, the ink in Example-3-6 (which possesses an average double bond density of 1.07) would give a better result than the ink in Example-3-1, in terms of the crosshatch adhesion test. However, this ink failed the tape adhesion test (with a scale of 0B) and interestingly, the OPV layer also completely peeled off from the ink layer when the can was given a pasteurization treatment. The ink in Example-3-5 (which possesses an average double bond density of 1.20) also showed the peeled off issue when the OPV-ink layer was given the cross-hatch adhesion test.

Therefore, in order for inkjet ink compositions to deliver the required performance for metal can decoration, they should have:
The ink compositions should contain certain hydrophilic components imparted by monomer(s), oligomer(s), or inert resin(s) so the cured inks possess the desired amphiphilic properties upon exposure to LED, UV, or EB radiation.
For low odor application, the average double bond density (or the average functionality) of the polymerizable components for the ink compositions can be regulated upon the type of the hydrophilic components used. A relatively high average double bond density (e.g., the average double density is 1.69 for the black ink in Example-3-1) can be beneficial.

TABLE 3-3
Ink performance of black ink composition having
different average double bond density

| | Ex- | Ex- | Ex- | Ex- | Ex- | Ex- |
|---|---|---|---|---|---|---|
| | ample- | ample- | ample- | ample- | ample- | ample- |
| | 3-1 | 3-2 | 3-3 | 3-4 | 3-5 | 3-6 |
| Odor scale of | 1 | 2 | 2 | 3 | 4 | 5 |
| cured ink | | | | | | |
| (ink only) | | | | | | |
| Odor scale of | L-1 | L-2 | L-2 | L-3 | L-3 | L-3 |
| finished can- | | | | | | |
| (ink/OPV) | | | | | | |
| Print density | 1.95 | 2.08 | 2.07 | 2.05 | 2.08 | 2.06 |
| of finished can | | | | | | |
| (ink/OPV) | | | | | | |
| Gloss of | 89.4 | 89.3 | 88.9 | 88.5 | 90.9 | 91.2 |
| finished can | | | | | | |
| (ink/OPV) | | | | | | |
| Cross hatch | 4B-5B | 0B | 0B | 3B | 1B | 0B |
| adhesion of | | | | | (ink/ | |
| finished can | | | | | opv) | |
| (ink/OPV) | | | | | | |
| MEK resistance | 50 | 50 | 50 | 50 | 20 | 20 |
| of finished can | plus | plus | plus | | | |
| (ink/OPV) | | | | | | |
| Pencil hardness | 2H | 2H | H | H | H | HB |
| of finished can | | | | | | |
| (ink/OPV) | | | | | | |
| Pasteurization | 4B-5B | 0B | 0B | 1B | 1B | 0B |
| of finished can | | | | | | (OPV/ |
| (ink/OPV)-by | | | | | | ink) |
| cross hatch 810 | | | | | | |
| tape evaluation | | | | | | |
| Pasteurization | Pass | Pass | Pass | Pass | Pass | Pass |
| of finished can | | | | | | |
| (ink/OPV)- | | | | | | |
| by blushing | | | | | | |
| evaluation | | | | | | |
| Pasteurization | Pass | Pass | Pass | Pass | Pass | Pass |
| of finished can | | | | | | |
| (ink/OPV)- | | | | | | |
| by color fading | | | | | | |
| evaluation | | | | | | |

### Example 4: YMCK Four Color Process Inkjet Inks

The yellow, magenta, cyan, black four-color process inkjet inks (Example-4-1 through to Example-4-4) were prepared by mixing the components listed in Table-4-1 using a Caframo constant-torque brushless mixer. Each of the blends were agitated at 500 rpm to 1500 rpm under 60° C. for 35 minutes. After that, the inks were filtered through a 1 micro filtering device (provided by Pall Canada) and then kept in a black jar, respectively.

TABLE 4-1
low odor YMCK four color process inks

| | Example- | Example- | Example- | Example- |
|---|---|---|---|---|
| | 4-1 | 4-2 | 4-3 | 4-4 |
| | Yellow | Magenta | Cyan | Black |
| | % | % | % | % |
| Hydrophilic mono- | 26.00 | 26.00 | 26.00 | 26.00 |
| functional monomer - 1 | | | | |
| Synergist | 7.95 | 4.35 | 8.85 | 8.60 |
| Photoinitiator - 1 | 4.50 | 4.50 | 4.50 | 4.50 |
| Photoinitiator - 2 | 3.50 | 3.50 | 3.50 | 3.50 |
| Photoinitiator - 3 | 1.65 | 1.65 | 1.65 | 1.65 |
| Di-functional monomer | 50.41 | 51.55 | 49.56 | 48.91 |
| Inhibitor - 2 | 1.50 | 1.50 | 1.50 | 1.50 |
| Inhibitor - 3 | 0.40 | 0.40 | 0.40 | 0.40 |
| Flow Agent | 0.10 | 0.10 | 0.10 | 0.10 |
| Dispersant - 1 | 1.14 | | | 1.61 |
| Dispersant - 2 | | 2.25 | 0.79 | |
| Inhibitor - 1 | 0.57 | 0.75 | 0.53 | 0.54 |
| Cyan Pigment | | | 2.63 | |
| Magenta Pigment | | 3.45 | | |
| Yellow Pigment | 2.28 | | | |
| Black Pigment | | | | 2.69 |
| Total | 100.00 | 100.00 | 100.00 | 100.00 |

### Ink Properties

The viscosity, static surface tension, and the odor of the inks in Example-4 were tested and evaluated by the same methods described in Example-2. The results are summarized in Table-4-2. All the inks above presented desirable viscosity values and surface tension values for inkjet application. They also showed the desirable low odor properties (with odor scale of A).

TABLE 4-2
Ink properties of low odor YMCK four process inks

| | Example- | Example- | Example- | Example- |
|---|---|---|---|---|
| | 4-1 | 4-2 | 4-3 | 4-4 |
| viscosity at 25° C. (cPs) | 16.9 | 17.5 | 16.3 | 18.5 |
| viscosity at 45° C. (cPs) | 8.34 | 8.80 | 8.14 | 9.04 |
| Surface tension (mN/m) | 25.22 | 25.61 | 25.14 | 25.67 |
| Odor scale of wet ink | A | A | A | A |

### Ink Performance

The performance of the inks prepared in Example 4 was evaluated using the same methods described in Example 2 above.

It can be seen from Table-4-3 that the cured inks follow the same pattern as the wet inks, in terms of the odor properties. The low odor inks (i.e., Example-4-1 to 4-4, with odor scale of A) generated lower odor prints once they were LED cured, with the odor scale of 1. When a water-based overprint varnish was applied to the corresponding low odor ink layer, the odor from the finished cans were also low, staying in L-1 range.

All the cans decorated with the above inks exhibited desirable print density, gloss level, pencil hardness, MEK rub resistance, and cross hatch adhesion property (4B-5B). All the cans decorated with the above inks were able to withstand the pasteurization treatment.

TABLE 4-3
Performance of low odor YMCK four process inks

| | Example- | Example- | Example- | Example- |
|---|---|---|---|---|
| | 4-1 | 4-2 | 4-3 | 4-4 |
| Odor scale of cured ink (ink | 1 | 1 | 1 | 1 |
| only) | | | | |
| Odor scale of finished can- | L-1 | L-1 | L-1 | L-1 |
| (ink/OPV) | | | | |
| Print density of finished can | 1.22 | 1.57 | 2.22 | 1.98 |
| (ink/OPV) | | | | |
| Gloss of finished can (ink/OPV) | 87.1 | 87.7 | 88.1 | 87.2 |
| Cross hatch adhesion of finished | 4B-5B | 4B-5B | 4B-5B | 4B-5B |
| can (ink/OPV) | | | | |
| MEK resistance of finished can | 50 plus | 50 plus | 50 plus | 50 plus |
| (ink/OPV) | | | | |
| Pencil hardness of finished can | 2H | 2H | 2H | 2H |
| (ink/OPV) | | | | |
| Pasteurization of finished can | 4B-5B | 4B-5B | 4B-5B | 4B-5B |
| (ink/OPV)- by cross hatch 810 | | | | |
| tape evaluation | | | | |
| Pasteurization of finished can | Pass | Pass | Pass | Pass |
| (ink/OPV)- by blushing | | | | |
| evaluation | | | | |
| Pasteurization of finished can | Pass | Pass | Pass | Pass |
| (ink/OPV)- by color fading | | | | |
| evaluation | | | | |

The average double bond density of the polymerizable components for the above YMCK inks were all around 1.55.

If tested, it would be found that the desired properties (low odor, good adhesion, good MEK rub resistance, good pasteurization resistance) can be achieved by using or incorporating other monomers, oligomers, inert resins, and additives within the teaching of the specification described herein. If adjustments were made in the compositions, it would be found that average double bond density of the polymerizable components can go as low as about 1 and as high as about 2.0 and the corresponding inks perform well in the metal can decoration.

### Example 5: Press Trial on White Base can

The YMCK inks prepared in Example 4 were assessed with a two-piece metal can SLED press (Inx International). This specially designed SLED unit was equipped with a Xaar1003 print head (3 mm distance from the substrates to be printed) and a 16 w/cm Phoseon LED lamp (10 mm distance from the substrates to be applied). The SLED press allows the can body to rotate in the circumferential direction around the can axis under the printhead while the inkjet composition was ejected. The coat weight of jetted ink may be adjusted by adapting several printing resolutions, for example, for a single-pass printing, a low resolution 360×360 can be engaged to provide a drop size of 42 pl. The imaging file for the press trial contained company logo, various tonal (25%, 50%, 75%, 100%), fine line (0.75 pt), and fine type (5 pt).

The above YMCK inks were jetted at 45° C. on an outer peripheral surface of a cylindrical 16 oz white base can through a single pass approach (coat weight 8.4 gram per square meter) in which the printed can was exposed to LED light at a liner speed of around 40 fpm (feet per minute). The 16 oz white base can was provided by Ball Corporation, USA and had a diameter of 66 mm and a printable height of 160 mm. A water-based acrylic/melamine overprint varnish (PPG3825803, commercially available from PPG) was applied, through a InterCan coater (supplied by Intercan, UK) onto the LED cured ink layer of the above white base can. The coat weight of the overprint varnish applied was controlled at 2.5 to 2.9 gram per square meter (in dry), or 80-100 mg per can (in dry). The can was then allowed to be oven baked at 380° F. for 3 minutes. After that, the finished print was evaluated in terms of its odor-ness, print quality, print density, gloss level, MEK rub resistance, pencil hardness, crosshatch adhesion, and pasteurization resistance.

The results in Table-5-1 indicated that the inks met the corresponding requirements for white base can decoration.

TABLE 5-1
Performance of low odor process ink when applied in press trial

| | Yellow ink | Magenta ink | Cyan ink | Black ink |
|---|---|---|---|---|
| | from | from | from | form |
| | Example- | Example- | Example- | Example- |
| | 4-1 | 4-2 | 4-3 | 4-4 |
| Odor scale of cured ink (ink only) | 1 | 1 | 1 | 1 |
| Odor scale of finished can- | L-1 | L-1 | L-1 | L-1 |
| (ink/OPV) | | | | |
| Print quality (solids, halftones, | Clean/sharp | Clean/sharp | Clean/sharp | Clean/sharp |
| types and lines) | | | | |
| Print density of finished can | 1.21 | 1.90 | 2.40 | 2.08 |
| (ink/OPV) | | | | |
| Gloss of finished can (ink/OPV) | 84.9 | 86.3 | 85.2 | 86.1 |
| Cross hatch adhesion of finished | 4B-5B | 4B-5B | 4B-5B | 4B-5B |
| can (ink/OPV) | | | | |
| MEK resistance of finished can | 50 plus | 50 plus | 50 plus | 50 plus |
| (ink/OPV) | | | | |
| Pencil hardness of finished can | 2H | 2H | 2H | 2H |
| (ink/OPV) | | | | |
| Pasteurization of finished can | 4B-5B | 4B-5B | 4B-5B | 4B-5B |
| (ink/OPV)- by cross hatch 810 | | | | |
| tape evaluation | | | | |
| Pasteurization of finished can | Pass | Pass | Pass | Pass |
| (ink/OPV)- by blushing evaluation | | | | |
| Pasteurization of finished can | Pass | Pass | Pass | Pass |
| (ink/OPV)- by color fading | | | | |
| evaluation | | | | |

### Low Extraction Evaluation

The residues of unreacted monomers, photoinitiators and other components in the finished cans from the press trial were determined by a total extraction test. This test involved (1) soaking the whole can into 10% ethanol at 40° C. for 2 hours and then removing the can from the ethanol simulants; (2) adding the Internal standards (deuterated benzophenone, deuterated anthracene, p-terphenyl) to the ethanol simulants, and having the simulants concentrated over a C18 SPE cartridge; (3) collecting the concentrated simulants with methanol and having it analyzed by GC-MS.

The extraction levels (Table-5-2) are calculated from the internal standards by using area count ratios and the results are reported as ppb (parts per billion), the equivalent amount of monomer (or photoinitiator) that would be present in 1 Kg of food according to the EU packaging model (where it is assumed that 6 dm² of substrate is required to package 1 Kg of food) if all the extractables in the print were to migrate into and contaminate the food.

TABLE 5-2
The extractable level from the low migration (LM) test

| Residues from monomer, oligomer, photoinitiation | Extractable |
|---|---|
| and its decomposition by products | level (ppb) |
| 2,4,6-trimethylbenzaldehyde, | 2 |
| 2,4,6-trimethylbenzoic acid, methyl ester | 6 |
| and 2,4,6-trimethylbenzoic acid | |

The LM test showed in this example that the extractable levels are not detectable (i.e., less than 1 ppb) for monomer residues, for photoinitiator-2 residues, and for photoinitiator-3 residues. The extractable levels for photoinitiator-1 residues are also sufficiently low (total 8 ppb). The 2,4,6-trimethylbenzaldehyde, the 2,4,6-trimethylbenzoic acid, and the methyl ester and 2,4,6-trimethylbenzoic acid are the decomposition by-products from photoinitiator-1.

### Example 6: Application of the Disclosed Inks to Other Substrates

The above YMCK inks from Example 5 were printed, with a #6 Mayer Rod, onto a variety of substrates (Table-6-1). These substrates are widely used in inkjet printing, flexo printing, and offset printing. Many of them are also used for food packaging, cosmetic packaging, and pharmaceutical packaging. The printed inks were LED cured through an AMS LED curing unit (provided by Air Motion System) equipped with a 17 w/cm LED lamp at a dose of 400 mj/cm² of total UV-A2. The prints were then evaluated immediately (within 10 seconds after curing) for surface odor. A score of 1 to 5 for surface odor was assigned to each print, where 5 denotes relatively strong, unpleasant odor and 1 denotes relatively insignificant odor emanating from the print. In general, the score of 1 is desirable for the corresponding applications of the energy cured prints.

The tape adhesion test of the cured inks can refer to the method of “the determination of ink/coating adhesion to a substrate using tape” which is similar to ASTM D3359 but with no use of crosshatch. It generally involves 3 steps: (1) place standard adhesive tape (3M's 610 Tape or 810 tape) onto the print and apply moderate pressure to ensure proper bonding between the adhesive tape and print; (2) pull tape off at a smooth rate of approximately 1 cm/sec at an angle of 120°-150°; and (3) observe the test results, where anything less than 100% stay of the cured ink on the substrate is considered “failure”. The 610-tape test and/or the 810-tape test are the methods more commonly used for paper-printing and plastic-printing applications.

As shown in Table-6-1, the cured inks exhibit good low odor characteristics (score of 1) and good tape adhesion on a variety of substrates, indicating their potential in paper, paper board, plastic, and plastic lamination applications.

TABLE 6-1
Adhesion and odor properties of cured inks on a variety of substrates

| | Odor scale | 610 tape | 810 tape |
|---|---|---|---|
| Substrates | of cured ink | adhesion | adhesion |
| Gloss vinyl (gloss polyvinyl chloride) | 1 | pass | pass |
| Matte Banner (matte polyvinyl chloride) | 1 | pass | pass |
| Gloss self- adhesive vinyl (removable | 1 | pass | pass |
| pressure sensitive microporous coated | | | |
| gloss polyvinyl chloride) | | | |
| GF post Satin paper (poster paper) | 1 | pass | pass |
| Corrugated plastic (corrugated | 1 | pass | pass |
| polypropylene) | | | |
| Foam core board (boards made from a | 1 | pass | pass |
| foam core between two sheets of paper) | | | |
| T1701 thermal transfer polypropylene | 1 | pass | pass |
| AC9502 semi-gloss paper | 1 | pass | pass |
| FCD 6914 white polyethylene | 1 | pass | pass |
| terephthalate (PET) | | | |
| FCD 6914 metalized white polyethylene | 1 | pass | pass |
| terephthalate (PET) | | | |
| Nylon (polyamides) | 1 | pass | fail |
| PVC (Polyvinyl chloride) | 1 | pass | pass |
| PET (polyethylene terephthalate) | 1 | pass | pass |
| OPP (oriented polypropylene) | 1 | pass | pass |
| PP (polypropylene) | 1 | pass | pass |
| White PE (polyethylene) | 1 | pass | pass |
| LDPE (low density polyethene) | 1 | pass | pass |
| BOPP (biaxially-oriented polypropylene) | 1 | pass | pass |
| YuPo (Synthetic Paper) | 1 | pass | pass |
| Biaxially-oriented polypropylene (BOPP) | 1 | pass | pass |
| with adhesive back | | | |
| PETG (Polyethylene terephthalate glycol) | 1 | pass | pass |

### Migration Levels of Cured Prints

The level of contamination from a cured surface of the print was determined by a ‘set-off’ extraction test. The cured prints prepared from GF post Satin paper were selected for conducting this test.

This test involved blocking 200 cm² of the printed/cured surface to a 100-micron sterling digital sheet, under a weight of 25 pounds for a period of 24 hours. The contaminated sterling digital sheet (through set-off) was cut into 1 dm², and then extracted into 30 ml of 10% ethanol at 40° C. (e.g., in oven) for 2 hours. BP-D10 and anthracene D-10 were added into the above extracted solution as internal standard. The solution containing the internal standard was then concentrated to 1 ml before it was analyzed by GC-MS. The extraction levels are calculated from the internal standards by using area count ratios and the results are reported as ppb (parts per billion).

The LM test showed that the extractable levels (Table-6-2) are not detectable for mono-functional monomer residues and for photoinitiator-3 residues. The extractable levels for photoinitiator-1 residues are also relatively low (total 19+2=21 ppb). The extractable level for photoinitiator-2 residue is around 14 ppb. The extractable level for di-functional monomer residue is around 28 ppb. They are both lower than 50 ppb. It can be expected that the extraction levels (contamination levels) may be further reduced if an over print clear is applied to cover the cured inks.

TABLE 6-2
The migration property of the cured inks on GF post Satin paper

| Residues from monomer, oligomer, photoinitiator | Extractable |
|---|---|
| and its decomposition by products | level (ppb) |
| Photoinitiator - 1 | 19 |
| Photoinitiator - 1 | 2 |
| Photoinitiator - 2 | 14 |
| Di-functional monomer | 28 |

For reasons of completeness, various aspects of the invention are set out in the following numbered clauses:

Clause 1. An ink composition comprising: a mono-functional monomer, the mono-functional monomer comprising a hydrophilic mono-functional monomer; a di-functional monomer; an optional colorant; and an optional photoinitiator, wherein a ratio between a weight of the di-functional monomer and a weight of the mono-functional monomer in the ink composition is greater than 0.1.

Clause 2. The ink composition of clause 1, wherein the ink composition comprises the mono-functional monomer at about 3% to about 80% by weight of the total ink composition.

Clause 3. The ink composition of clause 1 or 2, wherein the ink composition comprises the hydrophilic mono-functional monomer at about 3% to about 46% by weight of the total ink composition.

Clause 4. The ink composition of any one of clauses 1-3, wherein the hydrophilic mono-functional monomer comprises 4-hydroxybutyl acrylate (4HBA), diacetone acrylamide (DAAM), 2-[[(butylamino) carbonyl]oxy]ethyl acrylate, 2-hydroxy-3-phenoxypropyl acrylate, β-carboxyethyl acrylate, hydroxyethylcaprolactone acrylate, vinyl methyl oxazolidone (VMOX), or a mixture thereof.

Clause 5. The ink composition of any one of clauses 1-4, wherein the mono-functional monomer further comprises a hydrophobic mono-functional monomer.

Clause 6. The ink composition of any one of clauses 1-5, wherein the ink composition comprises the di-functional monomer at about 10% to about 80% by weight of the total ink composition.

Clause 7. The ink composition of any one of clauses 1-6, wherein the di-functional monomer comprises 3-methyl-1,5-pentanediyl diacrylate, propoxylated neopentyl glycol diacrylate, 1,10-decanediol diacrylate, 2-hydroxy 3-methacryl propyl acrylate, dipropylene glycol diacrylate, tripropylene glycol diacrylate, 1,6-hexanediol (2EO) diacrylate, propoxylated hexanediol diacrylate, and 2-(2-sinyloxyethoxy)ethyl acrylate, or a mixture thereof.

Clause 8. The ink composition of any one of clauses 1-7, wherein the ratio is about 0.4 to about 2.6.

Clause 9. The ink composition of any one of clauses 1-8, wherein the ink composition has an average double bond density of polymerizable components of greater than 1.

Clause 10. The ink composition of any one of clauses 1-9, wherein the ink composition comprises the colorant at about 1% to about 4% by weight of the total ink composition.

Clause 11. The ink composition of any one of clauses 1-10, wherein the colorant comprises a dye or a pigment.

Clause 12. The ink composition of any one of clauses 1-11, wherein the colorant comprises Yellow 185, Red 122, Blue 15:4, Black 7, White 6, Green 7, Orange 64, Violet 23, and Brown 25, or a combination thereof.

Clause 13. The ink composition of any one of clauses 1-12, wherein the colorant is dispersed in a dispersant.

Clause 14. The ink composition of clause 13, wherein the dispersant is a polymeric dispersant.

Clause 15. The ink composition of clause 13 or 14, wherein the dispersant is included at about 1% to about 25% by weight of the total dispersion.

Clause 16. The ink composition of any one of clauses 1-15, wherein the ink composition comprises the photoinitiator at no more than 15% by weight of the total ink composition.

Clause 17. The ink composition of any one of clauses 1-16, further comprising a tri-functional monomer, a high functionality monomer, or a combination thereof.

Clause 18. The ink composition of clause 17, wherein the ink composition comprises the tri-functional monomer at no more than 20% by weight of the total ink composition.

Clause 19. The ink composition of any one of clauses 1-18, further comprising an inert resin, an oligomer, a synergist, a stabilizer, a wetting/flow agent, a de-foamers, or a combination thereof.

Clause 20. The ink composition of any one of clauses 1-19, further comprising a synergist, a stabilizer, a flow agent, or a combination thereof.

Clause 21. The ink composition of any one of clauses 1-20, wherein the ink composition has one of the following: a viscosity of no more than 40 cPs at about 25° C.; a surface tension of no less than 20 mN/m at room temperature; a low odor profile as measured by an olfactory analysis; or a combination thereof.

Clause 22. An ink composition comprising, in percent by weight based on the weight of the total ink composition: about 5% to about 35% of a hydrophilic mono-functional monomer; about 30% to about 70% of a di-functional monomer; about 0% to about 4% of a colorant; and an optional photoinitiator, wherein the ink composition has an average double bond density of polymerizable components of greater than 1.5.

Clause 23. The ink composition of clause 22, wherein the hydrophilic mono-functional monomer comprises 4-hydroxybutyl acrylate (4HBA), diacetone acrylamide (DAAM), 2-[[(butylamino) carbonyl]oxy]ethyl acrylate, 2-hydroxy-3-phenoxypropyl acrylate, β-carboxyethyl acrylate, hydroxyethylcaprolactone acrylate, vinyl methyl oxazolidone (VMOX), or a mixture thereof.

Clause 24. The ink composition of clause 22 or 23, wherein the di-functional monomer comprises 3-methyl-1,5-pentanediyl diacrylate, propoxylated neopentyl glycol diacrylate, 1,10-decanediol diacrylate, 2-hydroxy 3-methacryl propyl acrylate, dipropylene glycol diacrylate, tripropylene glycol diacrylate, 1,6-hexanediol (2EO) diacrylate, propoxylated hexanediol diacrylate, and 2-(2-vinyloxyethoxy)ethyl acrylate, or a mixture thereof.

Clause 25. The ink composition of any one of clauses 22-24, further comprising a tri-functional monomer, a high functionality monomer, or a combination thereof.

Clause 26. The ink composition of any one of clauses 22-25, further comprising a synergist, a stabilizer, a flow agent, or a combination thereof.

Clause 27. A decorated substrate comprising: a substrate; and a cured ink composition derived from the ink composition of claim 1 on a surface of the substrate.

Clause 28. The decorated substrate of clause 27, wherein the substrate comprises a metal, a paper, a plastic, or a combination thereof.

Clause 29. The decorated substrate of clause 27 or 28, wherein the substrate is a metal container.

Clause 30. The decorated substrate of any one of clauses 27-29, wherein the cured ink composition has a coat weight of about 0.5 gsm to about 15 gsm.

Clause 31. The decorated substrate of any one of clauses 27-30, further comprising a precoating positioned between the surface of the substrate and the cured ink composition.

Clause 32. The decorated substrate of any one of clauses 27-31, wherein the precoating is a white base coat and has a coat weight of about 2.5 gsm to about 10.5 gsm.

Clause 33. The decorated substrate of any one of clauses 27-32, further comprising a coating positioned on a surface of the cured ink composition.

Clause 34. The decorated substrate of clause 33, wherein the coating is visually clear and has a coat weight of about 1.5 gsm to about 5 gsm.

Clause 35. The decorated substrate of any one of clauses 27-34, wherein the cured ink composition has a level of contamination from uncured monomer, photoinitiator, or a combination thereof of less than 50 parts per billion as measured by an alcohol extraction test.

Clause 36. A method of printing a decoration on a substrate, the method comprising: (a) applying an ink composition to a surface of a substrate, wherein the ink compositions comprises a mono-functional monomer, the mono-functional monomer comprising a hydrophilic mono-functional monomer, a di-functional monomer, an optional colorant, and an optional photoinitiator, wherein a ratio between a weight of the di-functional monomer and a weight of the mono-functional monomer in the ink composition is greater than 0.1; and (b) irradiating the ink composition with ultraviolet radiation, light emitting diode radiation, or electron beam radiation to cure the ink composition on the surface of the substrate to provide a decorated substrate.

Clause 37. The method of clause 36, wherein applying the ink composition comprises inkjetting.

Clause 38. The method of clause 36 or 37, wherein the substrate comprises a metal, a paper, a plastic, or a combination thereof.

Clause 39. The method of any one of clauses 36-38, wherein the substrate is a metal container.

Clause 40. The method of any one of clauses 36-39, wherein the substrate is coated with a white base coat prior to step (a).

Clause 41. The method of any one of clauses 36-40, further comprising laminating the cured ink composition with a varnish coating.

Clause 42. The method of any one of clauses 36-41, further comprising baking the decorated substrate at about 350° F. to about 400° F.

What is claimed is:

1. An ink composition comprising:
a mono-functional monomer, the mono-functional monomer comprising a hydrophilic mono-functional monomer;
a di-functional monomer;
an optional colorant; and
an optional photoinitiator,
wherein a ratio between a weight of the di-functional monomer and a weight of the mono-functional monomer in the ink composition is greater than 0.1.

2. The ink composition of claim 1, wherein the ink composition comprises the mono-functional monomer at about 3% to about 80% by weight of the total ink composition.

3. The ink composition of claim 1, wherein the ink composition comprises the hydrophilic mono-functional monomer at about 3% to about 46% by weight of the total ink composition.

4. The ink composition of claim 1, wherein the hydrophilic mono-functional monomer comprises 4-hydroxybutyl acrylate (4HBA), diacetone acrylamide (DAAM), 2-[[(butylamino) carbonyl]oxy]ethyl acrylate, 2-hydroxy-3-phenoxypropyl acrylate, β-carboxyethyl acrylate, hydroxyethylcaprolactone acrylate, vinyl methyl oxazolidone (VMOX) or a mixture thereof.

5. The ink composition of claim 1, wherein the mono-functional monomer further comprises a hydrophobic mono-functional monomer.

6. The ink composition of claim 1, wherein the ink composition comprises the di-functional monomer at about 10% to about 80% by weight of the total ink composition.

7. The ink composition of claim 1, wherein the di-functional monomer comprises 3-methyl-1,5-pentanediyl diacrylate, propoxylated neopentyl glycol diacrylate, 1,10-decanediol diacrylate, 2-hydroxy 3-methacryl propyl acrylate, dipropylene glycol diacrylate, tripropylene glycol diacrylate, 1,6-hexanediol (2EO) diacrylate, propoxylated hexanediol diacrylate, and 2-(2-vinyloxyethoxy)ethyl acrylate, or a mixture thereof.

8. The ink composition of claim 1, wherein the ratio is about 0.4 to about 2.6.

9. The ink composition of claim 1, wherein the ink composition has an average double bond density of polymerizable components of greater than 1.

10. The ink composition of claim 1, wherein the ink composition comprises the colorant at about 1% to about 4% by weight of the total ink composition.

11. The ink composition of claim 1, wherein the colorant comprises a dye or a pigment.

12. The ink composition of claim 1, wherein the colorant comprises Yellow 185, Red 122, Blue 15:4, Black 7, White 6, Green 7, Orange 64, Violet 23, and Brown 25, or a combination thereof.

13. The ink composition of claim 1, wherein the colorant is dispersed in a dispersant.

14. The ink composition of claim 13, wherein the dispersant is a polymeric dispersant.

15. The ink composition of claim 13, wherein the dispersant is included at about 1% to about 25% by weight of the total dispersion.

16. The ink composition of claim 1, wherein the ink composition comprises the photoinitiator at no more than 15% by weight of the total ink composition.

17. The ink composition of claim 1, further comprising a tri-functional monomer, a high functionality monomer, or a combination thereof.

18. The ink composition of claim 17, wherein the ink composition comprises the tri-functional monomer at no more than 20% by weight of the total ink composition.

19. The ink composition of claim 1, further comprising an inert resin, an oligomer, a synergist, a stabilizer, a wetting/flow agent, a de-foamers, or a combination thereof.

20. The ink composition of claim 1, further comprising a synergist, a stabilizer, a flow agent, or a combination thereof.

21. The ink composition of claim 1, wherein the ink composition has one of the following:
a viscosity of no more than 40 cPs at about 25° C.;
a surface tension of no less than 20 mN/m at room temperature;
a low odor profile as measured by an olfactory analysis; or
a combination thereof.

22. An ink composition comprising, in percent by weight based on the weight of the total ink composition:
about 5% to about 35% of a hydrophilic mono-functional monomer;
about 30% to about 70% of a di-functional monomer;
about 0% to about 4% of a colorant; and
an optional photoinitiator,
wherein the ink composition has an average double bond density of polymerizable components of greater than 1.5.

23. The ink composition of claim 22, wherein the hydrophilic mono-functional monomer comprises 4-hydroxybutyl acrylate (4HBA), diacetone acrylamide (DAAM), 2-[[(butylamino) carbonyl]oxy]ethyl acrylate, 2-hydroxy-3-phenoxypropyl acrylate, β-carboxyethyl acrylate, hydroxyethylcaprolactone acrylate, vinyl methyl oxazolidone (VMOX) or a mixture thereof.

24. The ink composition of claim 22, wherein the di-functional monomer comprises 3-methyl-1,5-pentanediyl diacrylate, propoxylated neopentyl glycol diacrylate, 1,10-decanediol diacrylate, 2-hydroxy 3-methacryl propyl acrylate, dipropylene glycol diacrylate, tripropylene glycol diacrylate, 1,6-hexanediol (2EO) diacrylate, propoxylated hexanediol diacrylate, and 2-(2-vinyloxyethoxy)ethyl acrylate, or a mixture thereof.

25. The ink composition of claim 22, further comprising a tri-functional monomer, a high functionality monomer, or a combination thereof.

26. The ink composition of claim 22, further comprising a synergist, a stabilizer, a flow agent, or a combination thereof.

27. A decorated substrate comprising:
a substrate; and
a cured ink composition derived from the ink composition of claim 1 on a surface of the substrate.

28. The decorated substrate of claim 27, wherein the substrate comprises a metal, a paper, a plastic, or a combination thereof.

29. The decorated substrate of claim 27, wherein the substrate is a metal container.

30. The decorated substrate of claim 27, wherein the cured ink composition has a coat weight of about 0.5 gsm to about 15 gsm.

31. The decorated substrate of claim 27, further comprising a precoating positioned between the surface of the substrate and the cured ink composition.

32. The decorated substrate of claim 31, wherein the precoating is a white base coat and has a coat weight of about 2.5 gsm to about 10.5 gsm.

33. The decorated substrate of claim 27, further comprising a coating positioned on a surface of the cured ink composition.

34. The decorated substrate of claim 33, wherein the coating is visually clear and has a coat weight of about 1.5 gsm to about 5 gsm.

35. The decorated substrate of claim 27, wherein the cured ink composition has a level of contamination from uncured monomer, photoinitiator, or a combination thereof of less than 50 parts per billion as measured by an alcohol extraction test.

36. A method of printing a decoration on a substrate, the method comprising:
(a) applying an ink composition to a surface of a substrate, wherein the ink compositions comprises
a mono-functional monomer, the mono-functional monomer comprising a hydrophilic mono-functional monomer,
a di-functional monomer,
an optional colorant, and
an optional photoinitiator, wherein a ratio between a weight of the di-functional monomer and a weight of the mono-functional monomer in the ink composition is greater than 0.1; and
(b) irradiating the ink composition with ultraviolet radiation, light emitting diode radiation, or electron beam radiation to cure the ink composition on the surface of the substrate to provide a decorated substrate.

37. The method of claim 36, wherein applying the ink composition comprises inkjetting.

38. The method of claim 36, wherein the substrate comprises a metal, a paper, a plastic, or a combination thereof.

39. The method of claim 36, wherein the substrate is a metal container.

40. The method of claim 36, wherein the substrate is coated with a white base coat prior to step (a).

41. The method of claim 36, further comprising laminating the cured ink composition with a varnish coating.

42. The method of claim 36, further comprising baking the decorated substrate at about 350° F. to about 400° F.
